(19) United States
(12) Patent Application Publication
(10) Pub. No.: US 2021/0146570 A1
(43) Pub. Date: May 20, 2021

(54) STATIONARY CROSS CUT SYSTEM

(71) Applicant: Kreg Enterprises, Inc., Huxley, IA (US)

(72) Inventors: Sam Miller, Huxley, IA (US); Jacob Martin, Des Moines, IA (US); Kevin Choi, Nevada, IA (US); Stacy Peterson, Ames, IA (US)

(21) Appl. No.: 16/951,334

(22) Filed: Nov. 18, 2020

Related U.S. Application Data
(60) Provisional application No. 62/937,386, filed on Nov. 19, 2019.

(51) Int. Cl. B27B 9/04; B23Q 9/00

(52) U.S. Cl. CPC B27B 9/04; B23Q 9/0042

(57) ABSTRACT

In one or more arrangements, a stationary cross cut system includes a base having an upper surface configured to receive a workpiece during a cutting operation. The system also includes first and second extendable support wings connected to the base. When extended, the first support wing supports a workpiece that extends past the first side of the base and the second support supports a workpiece that extends past the second side of the base. In some arrangements, the base includes first and second fences and is configured to receive the workpiece between the first and second fences. In some arrangements, the system also includes a first rail extending between the first fence and the second fence and a second rail extending between the first fence and the second fence. The first rail and second rail are configured to receive and guide a cutting tool during the cutting operation.

### CROSS REFERENCE TO RELATED APPLICATION

This application claims the benefit of U.S. Provisional Application No. 62/937,386, titled “STATIONARY CROSS CUT SYSTEM” and filed on Nov. 19, 2019, the entirety of which is incorporated herein fully by reference.

### FIELD OF THE DISCLOSURE

This disclosure relates generally to wood working. More particularly, and without limitation, this disclosure relates to cutting workpieces with a stationary cross cut system.

### OVERVIEW OF THE DISCLOSURE

A number of systems and devices have been developed for cutting wood and other materials. Common types of cutting systems include: band saws, circular saws, miter saws and table saws. Each of these saw configurations have their own unique benefits as well as their own unique disadvantages and drawbacks.

Band saws are formed of a rotating saw blade that is formed in the shape of a band or continuous loop. This blade is relatively narrow and therefore band saws are tremendously well suited for cutting intricate shapes or features in both large and small pieces of material. While effective in many applications, band saws suffer from many disadvantages.

Namely, band saws are not well suited for making long straight cuts due to the narrow configuration of the blade. In addition, due to the large blade, band saws are generally large in stature which makes them stationary, and not portable, tools limited to use within the confines of a workshop. In addition, band saw blades are generally expensive. Also, band saws generally have a slow through-put. Another disadvantage of band saws is that the blade can be easily moved by grains in the wood due to the flexible nature and narrow width of the blade, which adds inaccuracy to straight cuts. For these reasons, band saws are not well suited or desirable for many cutting operations or many users.

Table saws are generally formed of a rotating blade that that sticks upward from a table top surface. Table saws are generally well suited for making straight cuts in pieces of plank material. While table saws can be used with great precision to make straight cuts, table saws suffer from many disadvantages.

Namely, due to the rotating blade sticking up from the table top surface, table saws have a generally sinister appearance and therefore many users are scared or intimidated by table saws. While some of the bad reputation table saws have is partially fiction, it is true that the exposed blade is very dangerous, especially when used by the novice user. Another disadvantage of table saws is that due to the fact that the blade protrudes from a table-top-like surface, table saws are relatively large, heavy, complicated and expensive devices. Due to their large size, table saws cannot be used in many settings or are not convenient for use in many applications such as on a jobsite as they are not very mobile or easy to set up on-site. Instead, table saws, like band saws, are generally reserved for use within the confines of a workshop. Yet another disadvantage of table saws is that they have a tendency to kick-back material during cutting.

A kick back occurs when a piece of material binds between the rotating blade and a guide surface or when a workpiece begins to twist or rotate while being cut. This often results in the blade pushing, kicking or throwing the workpiece back toward the user, sometimes in a catastrophic manner. This can be a very dangerous situation, not to mention a very scary one.

Another disadvantage of table saws is that they can be very difficult to use when cutting large sheets of material because the entire piece of material must be moved, not to mention moved in a manner that prevents binding and kick-back. If the piece of material is not precisely moved it can bind on the blade and kick back. Yet another disadvantage of table saws is that they require a lot of skill and experience to fully utilize the table saw in a safe manner. For these reasons, table saws are not well suited or desirable for many cutting operations or many users.

Circular saws are generally formed of a handheld motor connected to a rotating blade. Circular saws are relatively inexpensive, and unlike table saws, circular saws generally have a blade cover that at least tries to protect the user from the blade when not in use. This blade cover provides at least the appearance of safety which makes many users much more comfortable using a circular saw as opposed to a table saw. Also, due to their small size, circular saws are relatively easy to move and operate. In addition, circular saws are easy to transport and therefore circular saws are well suited for job-site use and are not constrained to use only within a workshop.

While circular saws have many advantages, they also have many disadvantages. Namely, due to their small size it is hard to accurately make cuts. In addition, it is difficult to make a long and straight cut with circular saws. Another disadvantage to circular saws is that the cuts are often not clean and precise, especially at the start of a cut. For these and other reasons, despite their advantages, circular saws suffer from many substantial disadvantages and limitations.

Miter saws are generally formed of a rotating saw blade that vertically pivots on a hinge and plunges toward a base and into and through a workpiece placed on the base. Miter saws are particularly well suited to make perpendicular cuts in smaller width workpieces that may be anywhere from extremely long to extremely short. Miter saws also angularly pivot so as to facilitate a wide range of angular cuts. Miter saws can be used to make highly precise and repeatable cuts. Miter saws are relatively inexpensive, and unlike table saws, miter saws generally have a blade cover that at least tries to protect the user from the blade. Miter saws are relatively portable.

While miter saws have many advantages, they also have many disadvantages. Namely, miter saws cannot be used for cutting through wide and/or thick workpieces. In addition, it is difficult to see exactly where a cut is going to be made on a workpiece prior to making the cut, which leads to inaccurate cuts as well as delay in making the cuts. That is, there is no easily perceptible indication where the cut is going to be made on the workpiece prior to actually performing the cut. For these and other reasons, despite their advantages, miter saws suffer from many substantial disadvantages and limitations.

As such, the prior art cutting systems suffer from many substantial disadvantages including being: unsafe, inaccurate, large, expensive, hard to use, hard to transport, they have limited accuracy, they are hard to guide, and they form low quality cuts, among many other disadvantages.

Therefore, for all the reasons stated above, and the reasons stated below, there is a need in the art for an improved stationary cross cut system that provides functionalities and capabilities never before present in a system.

Thus, it is a primary object of the disclosure to provide a stationary cross cut system that improves upon the state of the art.

Another object of the disclosure is to provide a stationary cross cut system that is safe to use.

Yet another object of the disclosure is to provide a stationary cross cut system that is efficient to use.

Another object of the disclosure is to provide a stationary cross cut system that is relatively inexpensive.

Yet another object of the disclosure is to provide a stationary cross cut system that is capable of making straight cuts accurately.

Another object of the disclosure is to a stationary cross cut system that is capable of making angled cuts accurately.

Yet another object of the disclosure is to provide a stationary cross cut system that can be used with workpieces with a wide range of thicknesses.

Another object of the disclosure is to provide a stationary cross cut system that can be used with workpieces with a wide range of lengths.

Yet another object of the disclosure is to provide a stationary cross cut system that can be used with workpieces with a wide range of widths.

Another object of the disclosure is to provide a stationary cross cut system that is unique.

Yet another object of the disclosure is to provide a stationary cross cut system that is easy to learn how to use.

Another object of the disclosure is to provide a stationary cross cut system that is relatively small in size and shape.

Yet another object of the disclosure is to provide a stationary cross cut system that provides many of the benefits of a miter saw.

Another object of the disclosure is to provide a stationary cross cut system that provides many of the benefits of a table saw.

Yet another object of the disclosure is to provide a stationary cross cut system that provides many of the benefits of a circular saw.

Another object of the disclosure is to provide a stationary cross cut system that holds workpieces in a firm and rigid manner.

Yet another object of the disclosure is to provide a stationary cross cut system that is easy to set up.

Another object of the disclosure is to provide a stationary cross cut system that is easy to take down.

Yet another object of the disclosure is to provide a stationary cross cut system that is easy to precisely adjust.

Another object of the disclosure is to provide a stationary cross cut system that can be precisely matched to the blade of a cutting tool.

Yet another object of the disclosure is to provide a stationary cross cut system that is formed of a minimum number of parts.

Another object of the disclosure is to provide a stationary cross cut system that is simple to use.

Yet another object of the disclosure is to provide a stationary cross cut system that is easier to use than prior art systems.

Another object of the disclosure is to provide a stationary cross cut system that is more-accurate to use than prior art systems.

Yet another object of the disclosure is to provide a stationary cross cut system that provides new capabilities to existing tools.

Another object of the disclosure is to provide a stationary cross cut system that has a robust design.

Yet another object of the disclosure is to provide a stationary cross cut system that is high quality.

Another object of the disclosure is to provide a stationary cross cut system that is durable.

Yet another object of the disclosure is to provide a stationary cross cut system that has a long useful life.

Another object of the disclosure is to provide a stationary cross cut system that provides accurate and clean cuts.

Yet another object of the disclosure is to provide a stationary cross cut system that saves time.

Another object of the disclosure is to provide a stationary cross cut system that is fun to use.

Yet another object of the disclosure is to provide a stationary cross cut system that can be used with workpieces of practically any material.

Another object of the disclosure is to provide a stationary cross cut system that is easily stationary and can be used on a job site.

Yet another object of the disclosure is to provide a stationary cross cut system that makes it easier to measure cuts.

Another object of the disclosure is to provide a stationary cross cut system that makes measuring more repeatable than prior art systems.

Yet another object of the disclosure is to provide a stationary cross cut system that can be used with practically any cutting tool.

Another object of the disclosure is to provide a stationary cross cut system that provides precise alignment for a cutting tool.

These and other objects, features, or advantages of the disclosure will become apparent from the specification, figures and claims.

### SUMMARY OF THE DISCLOSURE

A stationary cross cut system for cutting of a workpiece is presented.

In one or more arrangements, a stationary cross cut system includes a base having an upper surface configured to receive a workpiece during a cutting operation. The system also includes first and second support wings connected to the base. The first support wing is positioned adjacent a first side of the base. The second support wing is positioned adjacent a second side of the base. The first support wing moves between a retracted position and an extended position. The second support wing moves between a retracted position and an extended position. In this example arrangement, when the first support wing is in an extended position, the first support wing supports a workpiece that extends past the first side of the base. In this example arrangement, when the second support wing is in an extended position, the second support supports a workpiece that extends past the second side of the base.

In one or more arrangements, a stationary cross cut system includes a base having a first fence, a second fence, and an upper surface configured to receive a workpiece between the first and second fences during a cutting operation. In this example arrangement, the system also includes a first rail extending between the first fence and the second fence and a second rail extending between the first fence and the second fence. The first rail and second rail are configured to receive and guide a cutting tool during a cutting operation. In this example arrangement, the system also includes first and second support wings connected to the base. The first support wing is positioned adjacent a first side of the base. The second support wing is positioned adjacent a second side of the base. The support wings are movable between a retracted position and an extended position. When the first support wing is in an extended position, the first support wing supports a workpiece that extends past the first side of the base. When the second support wing is in an extended position, the second support supports a workpiece that extends past the second side of the base. In some arrangements, the system also includes an alignment member connected to the base. The alignment member configured to provide angular alignment to the workpiece during a cutting operation.

In one or more arrangements, a stationary cross cut system includes a base having an upper surface configured to receive a workpiece during a cutting operation. The system also includes first and second support wings connected to the base. The first support wing positioned adjacent a first side of the base. The second support wing positioned adjacent a second side of the base. The first support wing moves between a retracted position and an extended position.

The second support wing moves between a retracted position and an extended position. In this example arrangement, when the first support wing is in an extended position, the first support wing supports a workpiece that extends past the first side of the base. In this example arrangement, when the second support wing is in an extended position, the second support supports a workpiece that extends past the second side of the base. In this example arrangement, the support wings each include an arm and a support block, in which the support block is removable from the arm. When a first end of the workpiece extends past the first side of the base a distance greater than the length of one or more support wings, the support block of the support wing is configured to be removed and placed under the first end of the workpiece thereby supporting the first end of the workpiece remote from the base.

### BRIEF DESCRIPTION OF THE DRAWINGS

FIG. 1 shows a topside view of a stationary cross cut system, in accordance with one or more embodiments.

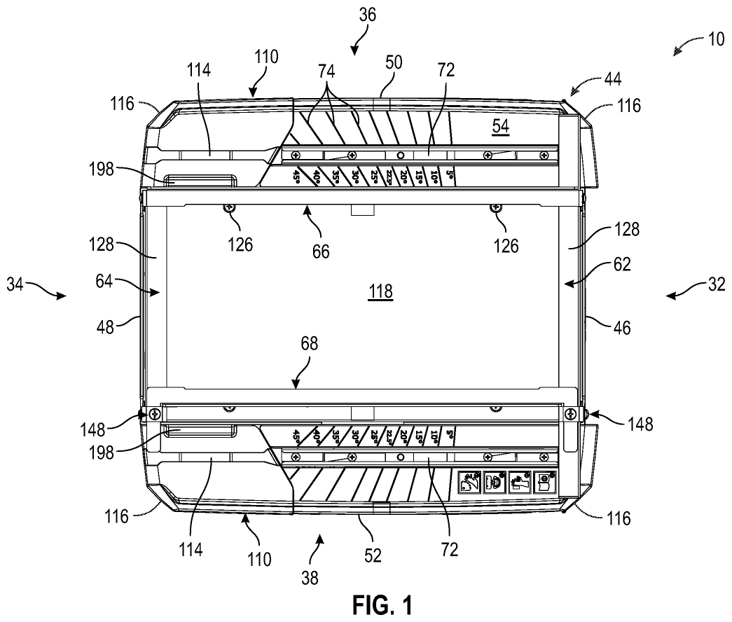

FIG. 2 shows a bottom side view of a stationary cross cut system, in accordance with one or more embodiments.

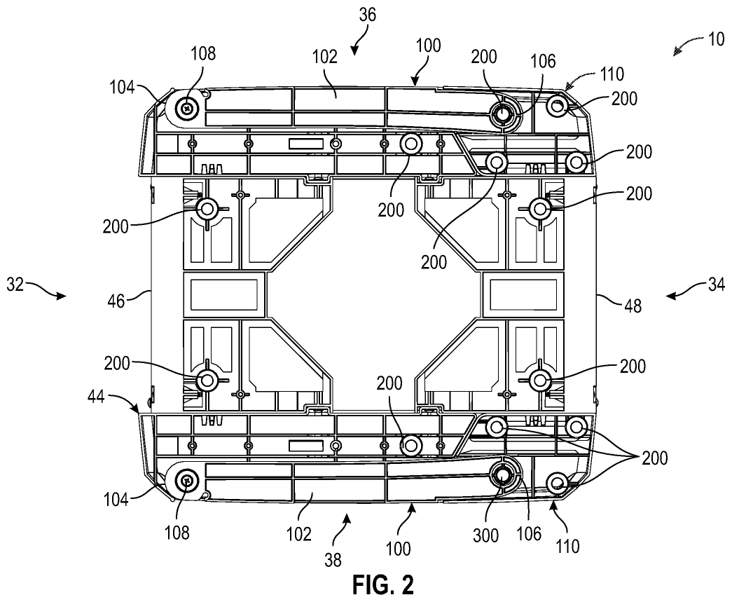

FIG. 3 shows a front view of a stationary cross cut system, in accordance with one or more embodiments.

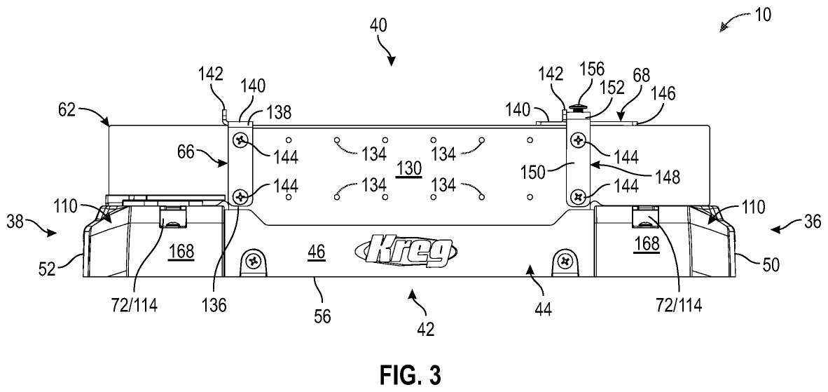

FIG. 4 shows a rear view of a stationary cross cut system, in accordance with one or more embodiments.

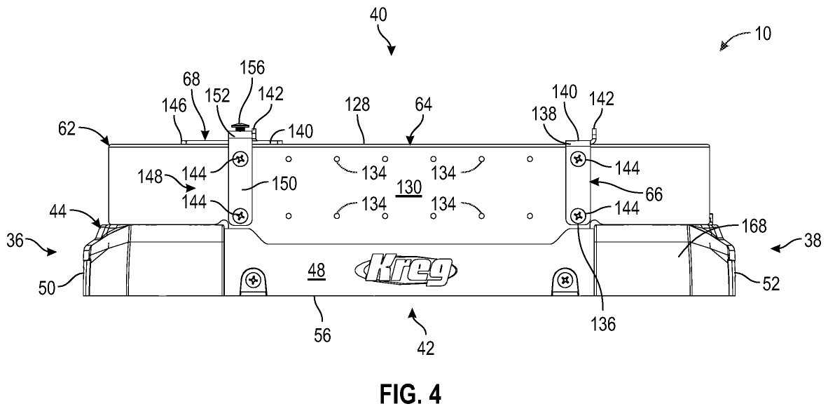

FIG. 5 shows a left side view of a stationary cross cut system, in accordance with one or more embodiments.

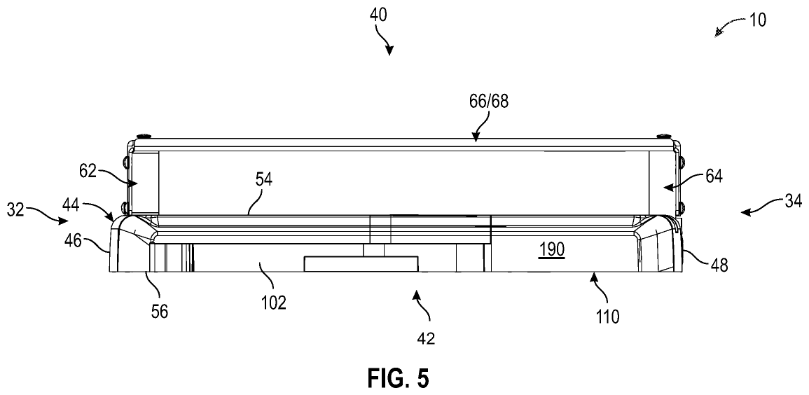

FIG. 6 shows a right side view of a stationary cross cut system, in accordance with one or more embodiments.

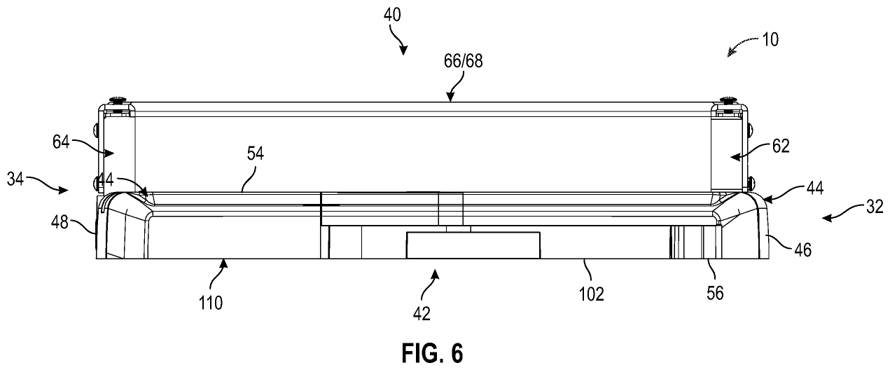

FIG. 7 shows an upper rear left side perspective view of a stationary cross cut system, in accordance with one or more embodiments.

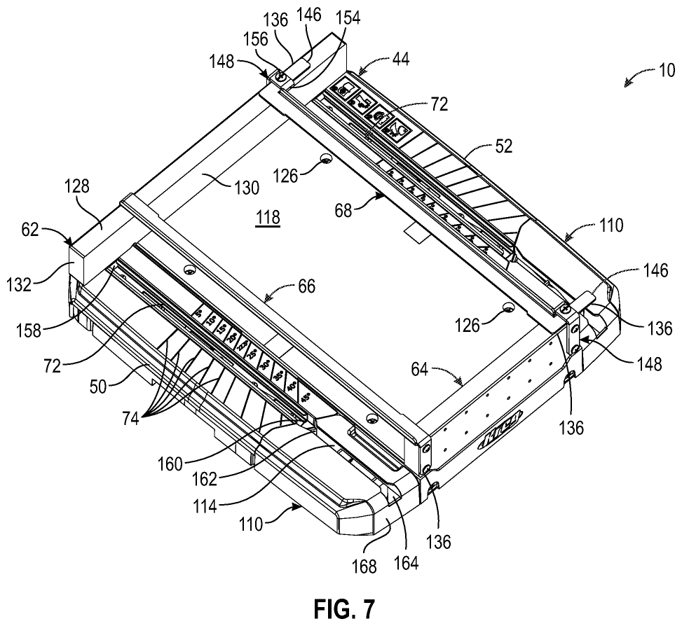

FIG. 8 shows an upper front left side perspective view of a stationary cross cut system, in accordance with one or more embodiments.

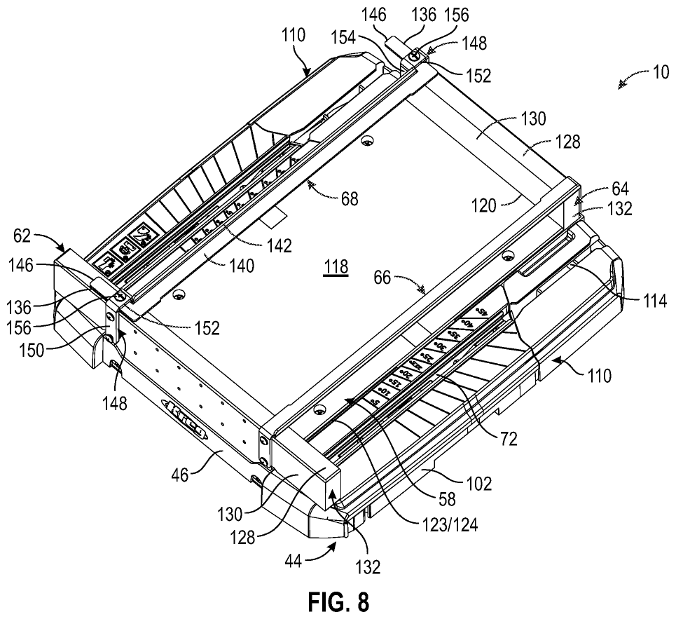

FIG. 9 shows an upper rear right side perspective view of a stationary cross cut system, in accordance with one or more embodiments.

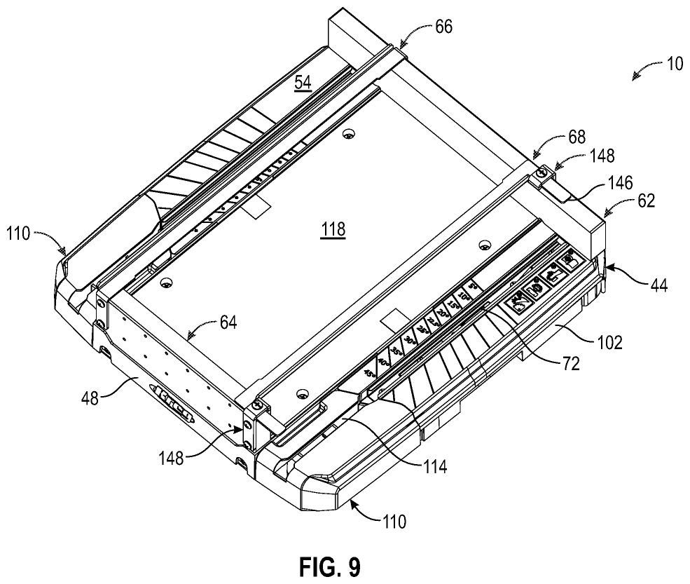

FIG. 10 shows an upper front right side perspective view of a stationary cross cut system, in accordance with one or more embodiments.

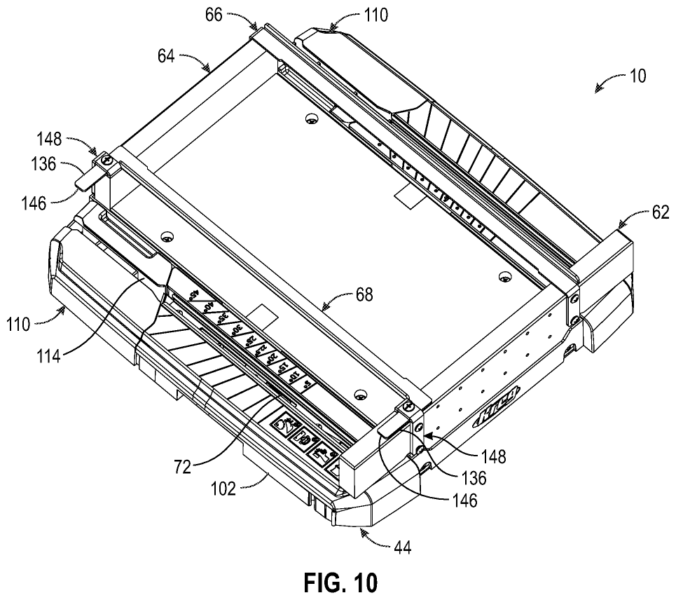

FIG. 11 shows a lower front right side perspective view of a stationary cross cut system, in accordance with one or more embodiments.

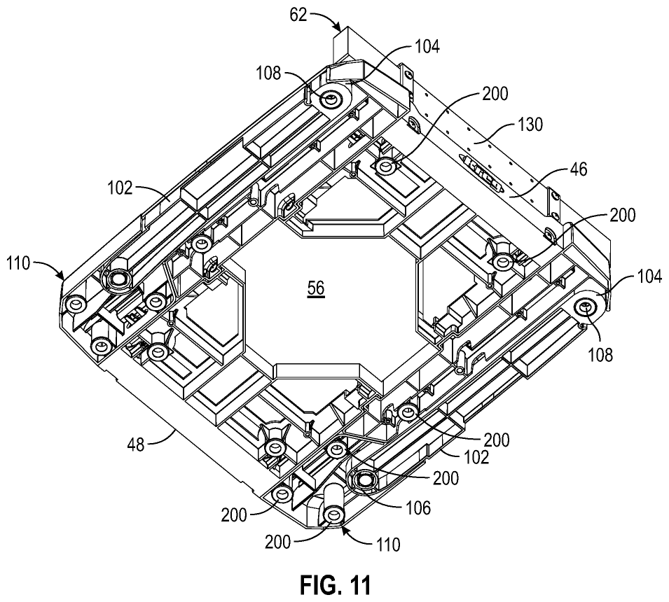

FIG. 12 shows a lower front left side perspective view of a stationary cross cut system, in accordance with one or more embodiments.

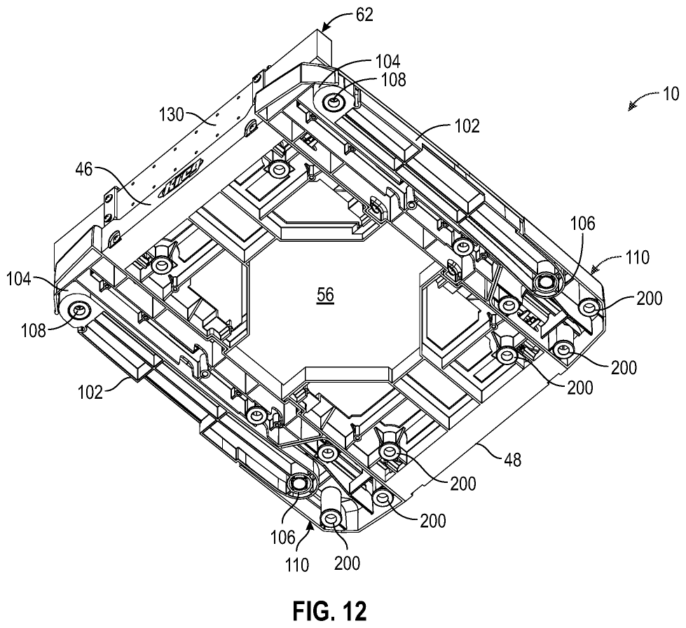

FIG. 13 shows a lower rear right side perspective view of a stationary cross cut system, in accordance with one or more embodiments.

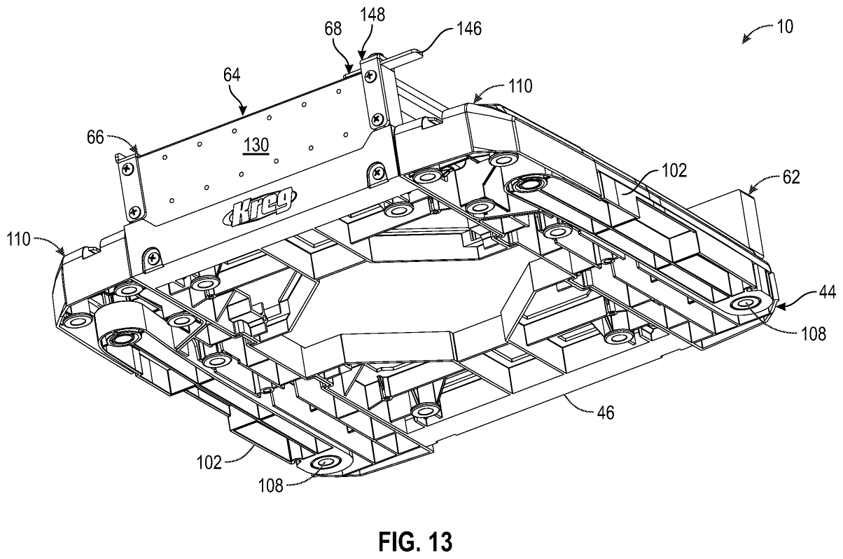

FIG. 14 shows a lower rear left side perspective view of a stationary cross cut system, in accordance with one or more embodiments.

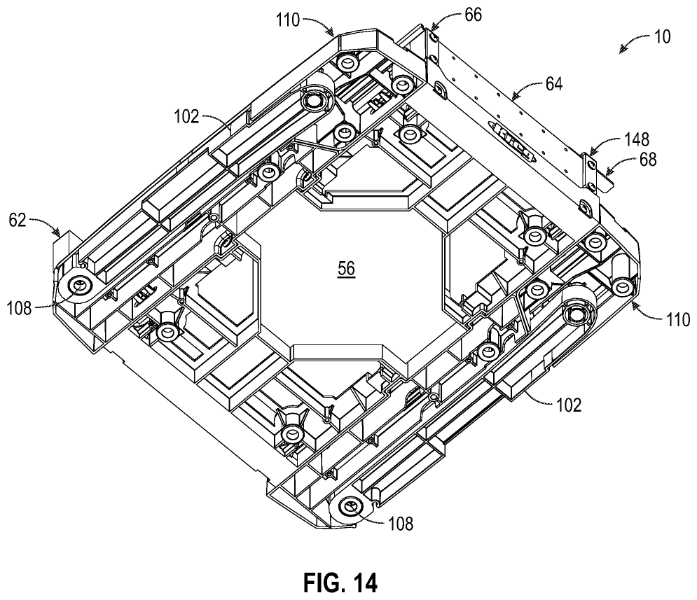

FIG. 15 shows a close up rear left side perspective view of a rear right corner of a stationary cross cut system, in accordance with one or more embodiments; the view showing a clamp aligned for insertion into a track of the stationary cross cut system.

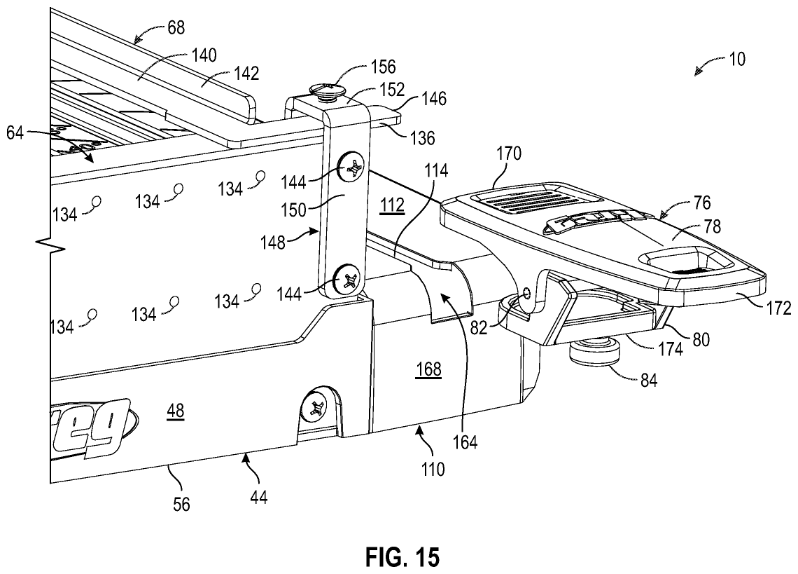

FIG. 16 shows an upper rear perspective view of a rear right corner of a stationary cross cut system, in accordance with one or more embodiments; the view showing a clamp inserted into a track of the stationary cross cut system.

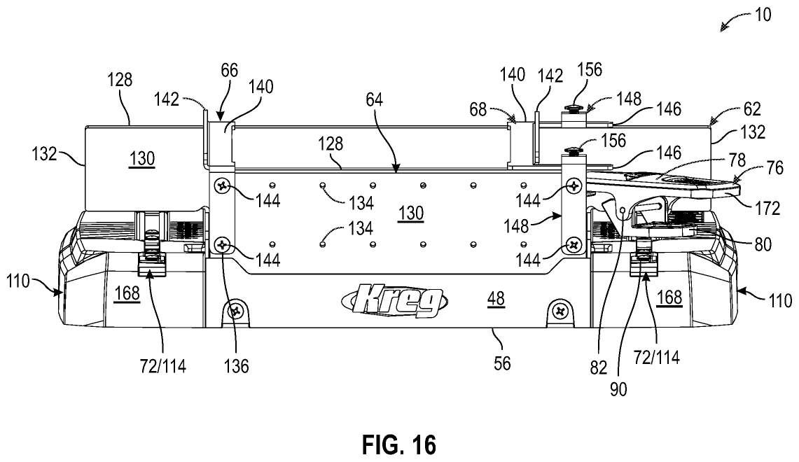

FIG. 17 shows an upper rear right side perspective view of a stationary cross cut system, in accordance with one or more embodiments; the view showing a clamp inserted into a track of the stationary cross cut system.

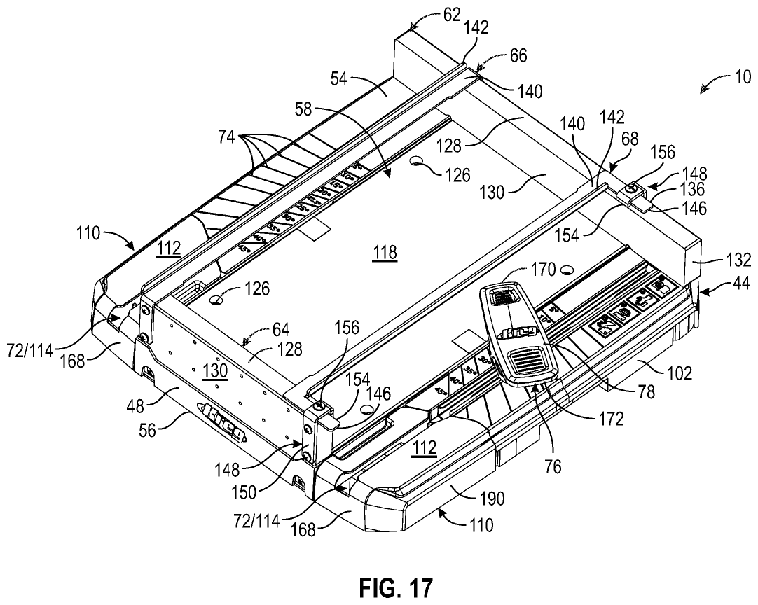

FIG. 18 shows an upper front left side perspective view of a stationary cross cut system, in accordance with one or more embodiments.

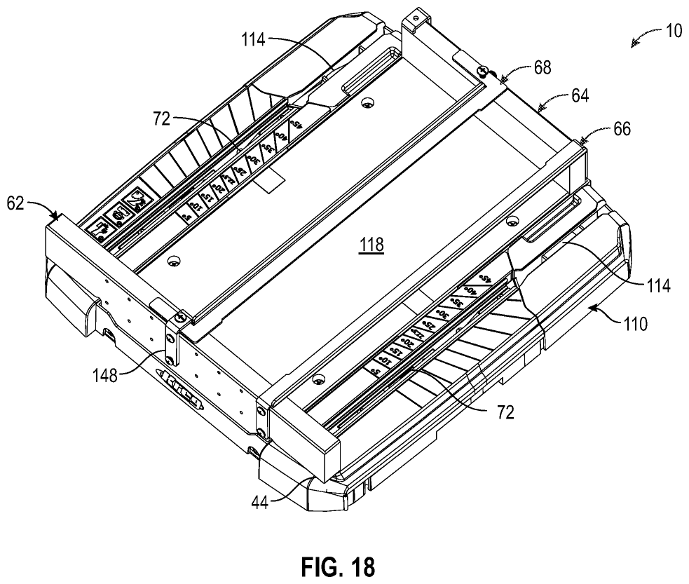

FIG. 19 shows an upper front left side perspective view of a stationary cross cut system, in accordance with one or more embodiments; the view showing a left support wing of the stationary cross cut system moved to an extended position.

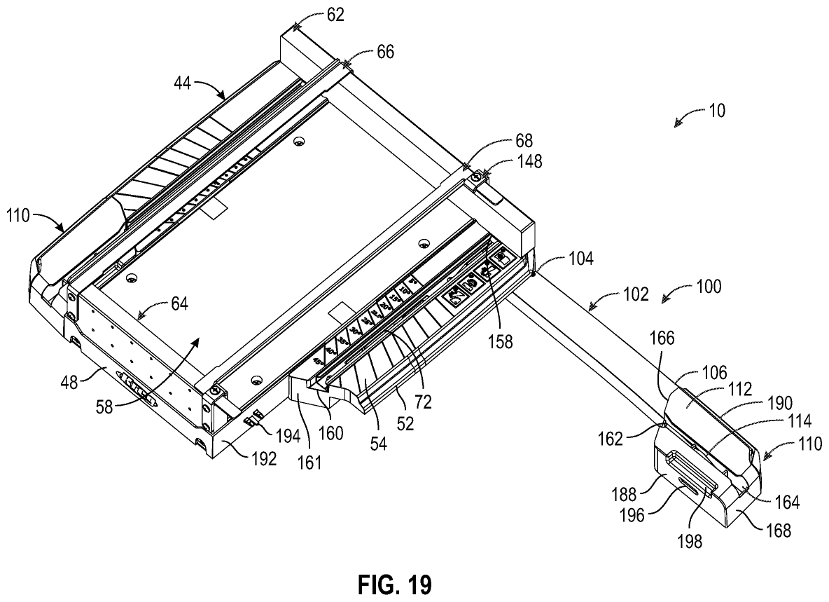

FIG. 20 shows an upper front left side perspective view of a stationary cross cut system, in accordance with one or more embodiments; the view showing a left support wing of the stationary cross cut system moved to an extended position and supporting a workpiece thereon.

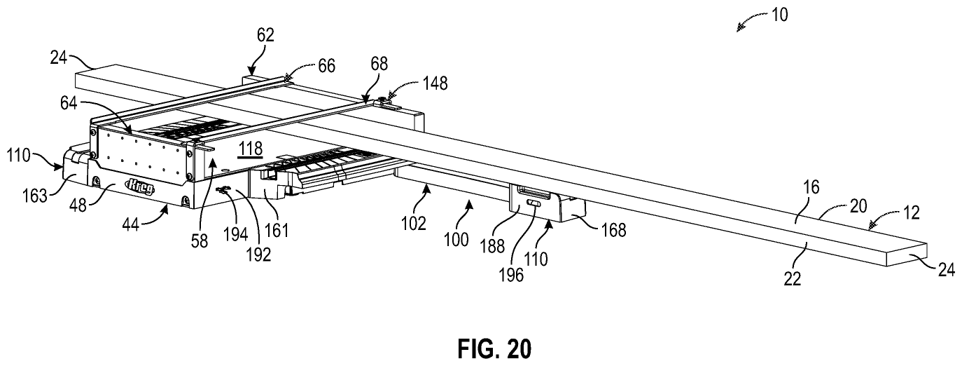

FIG. 21 shows an upper front right side perspective view of a stationary cross cut system, in accordance with one or more embodiments; the view showing a right support block detached from the right support wing and supporting a workpiece thereon.

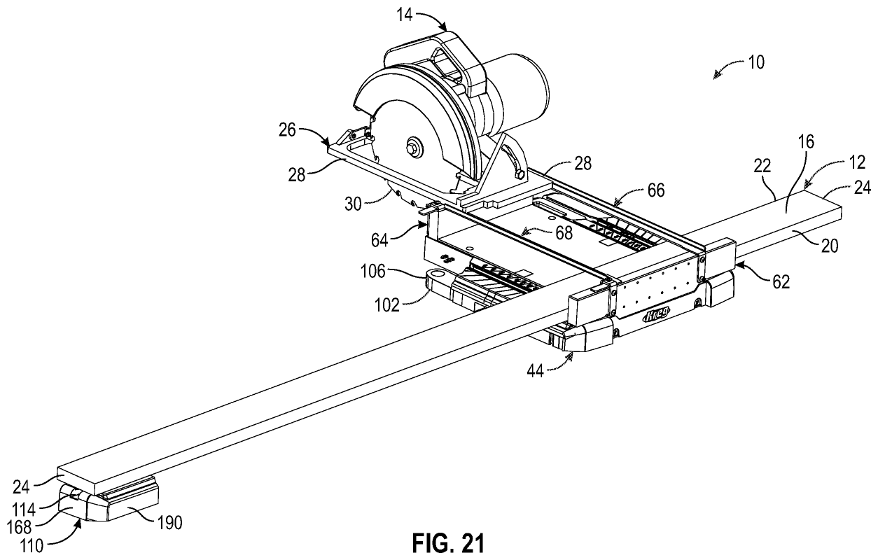

FIG. 22 shows an upper rear right side perspective view of a stationary cross cut system, in accordance with one or more embodiments; the view showing a left and right support wings of the stationary cross cut system moved to an extended position.

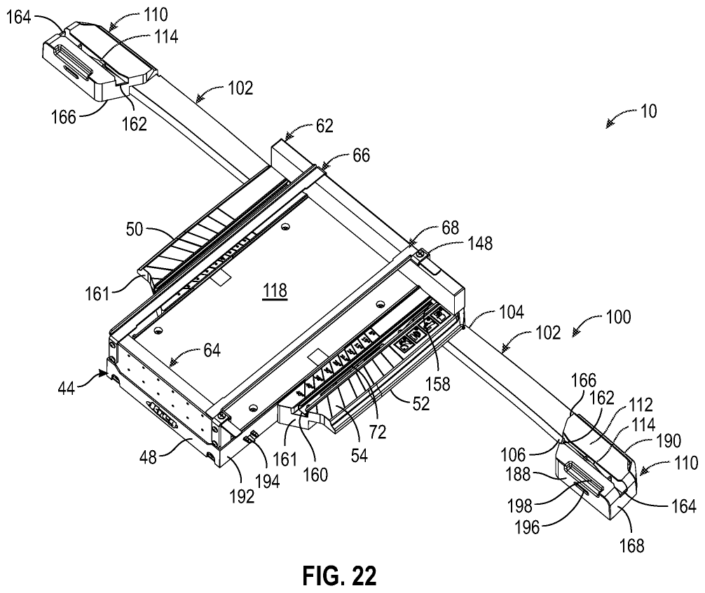

FIG. 23 shows an upper front right side perspective view of a stationary cross cut system, in accordance with one or more embodiments; the view showing a left and right support wings of the stationary cross cut system moved to an extended position and supporting a workpiece thereon; the view showing a cutting tool guided by guide rails of the stationary cross cut system to facilitate cutting of the workpiece.

FIG. 24 shows an upper front right side perspective view of a stationary cross cut system, in accordance with one or more embodiments; the view showing a right and left support blocks detached from the support wings and supporting a workpiece on opposite sides of the system; the view showing a cutting tool guided by guide rails of the stationary cross cut system to facilitate cutting of the workpiece.

FIG. 25 shows an upper front left side perspective view of a stationary cross cut system, in accordance with one or more embodiments; the view showing a right and left support blocks detached from the support wings and supporting a workpiece on the left side of the system; the view showing a cutting tool guided by guide rails of the stationary cross cut system to facilitate cutting of the workpiece.

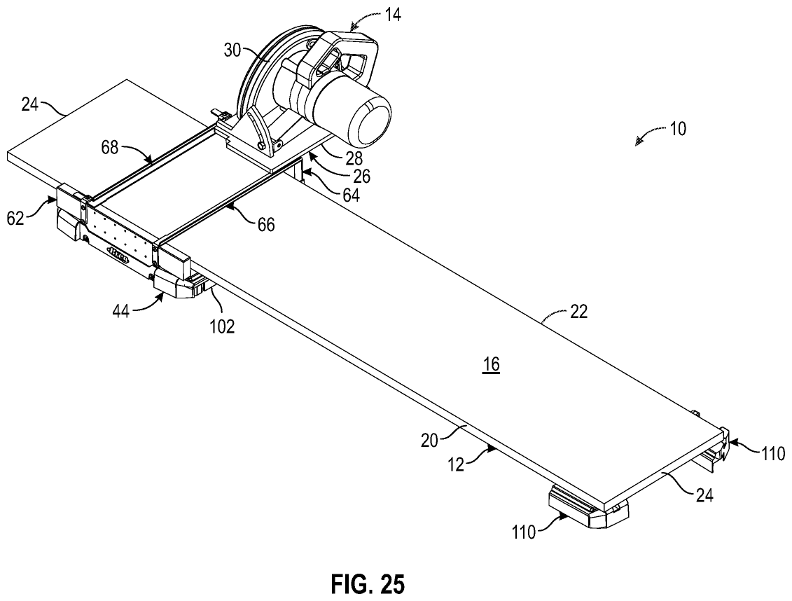

FIG. 26 shows an exploded view of an alignment member configured for use with a stationary cross cut system, in accordance with one or more embodiments.

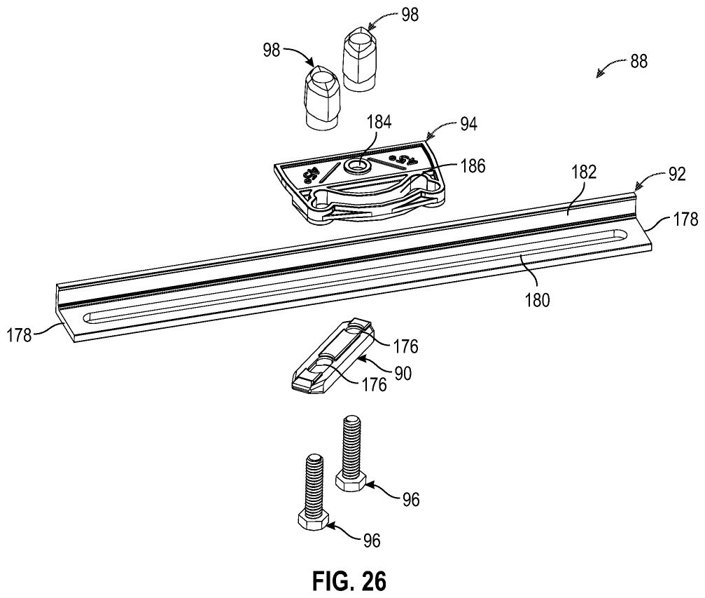

FIG. 27 shows an upper side end view of an alignment member configured for use with a stationary cross cut system, in accordance with one or more embodiments.

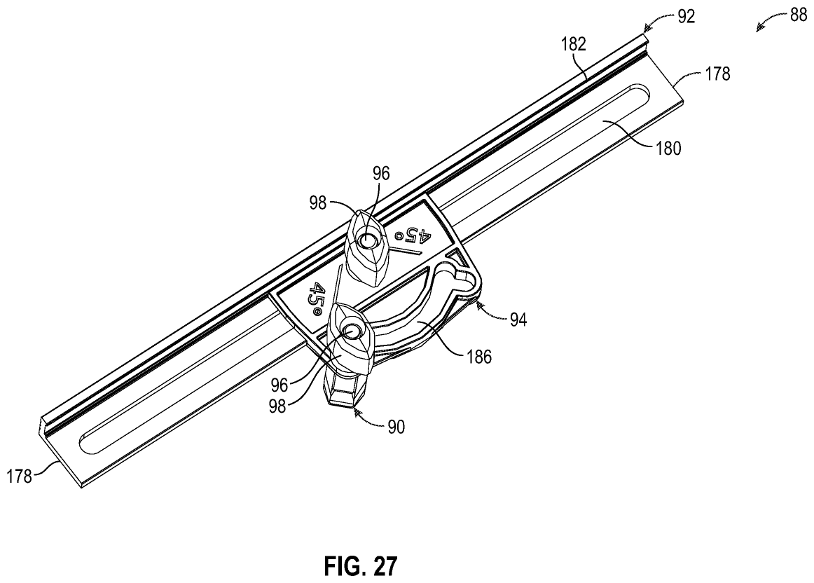

FIG. 28 shows an upper rear left side perspective view of a stationary cross cut system, in accordance with one or more embodiments; the view showing an alignment member positioned for insertion into a track of the stationary cross cut system.

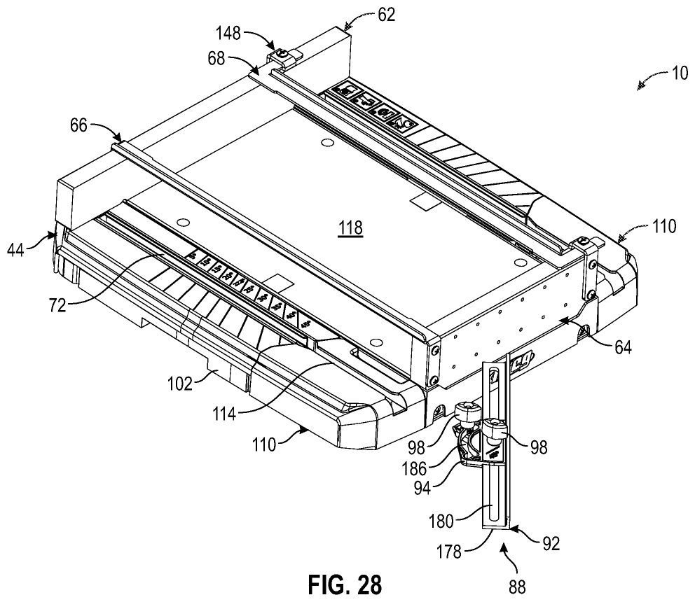

FIG. 29 shows an upper rear left side perspective view of a stationary cross cut system, in accordance with one or more embodiments; the view showing an alignment member inserted into a track of the stationary cross cut system.

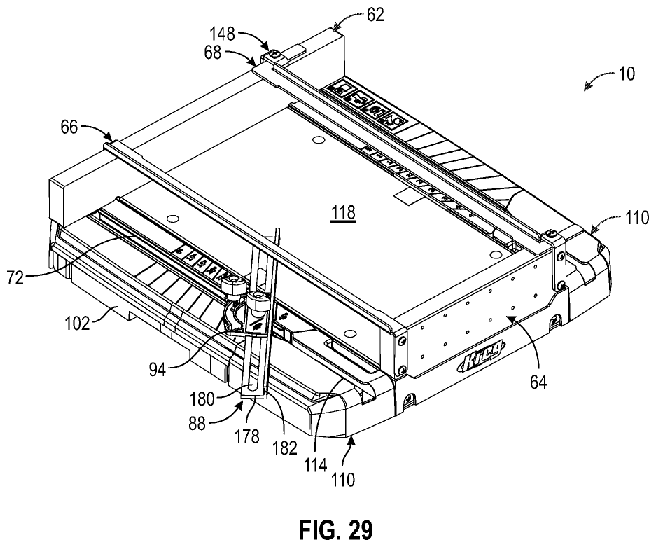

FIG. 30 shows a top side view of a stationary cross cut system, in accordance with one or more embodiments; the view showing an alignment member inserted into a track of the stationary cross cut system.

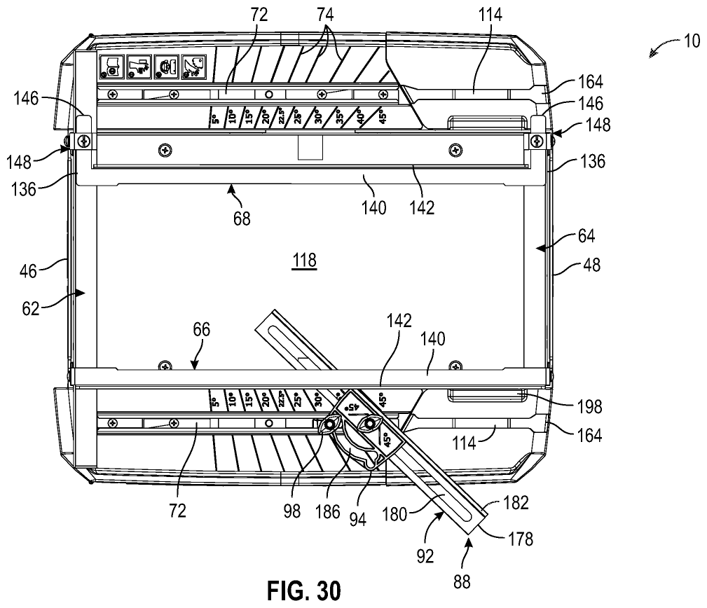

FIG. 31 shows an upper rear left side perspective view of a stationary cross cut system, in accordance with one or more embodiments; the view showing an alignment member inserted into a track of the stationary cross cut system; the view showing the alignment member being used for alignment of a workpiece.

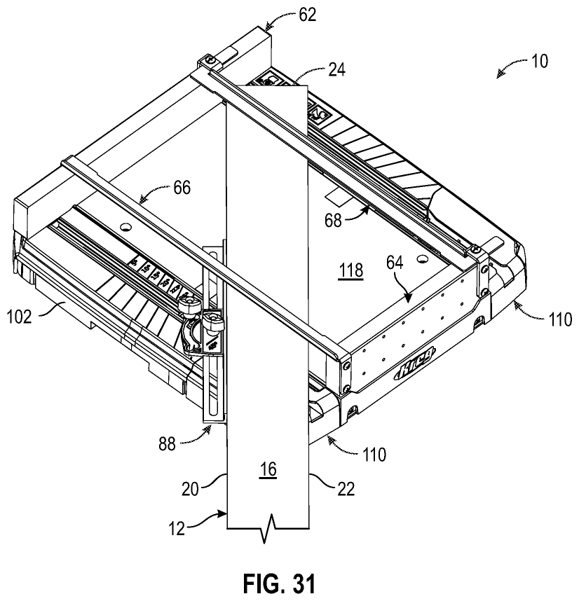

FIG. 32 shows an upper front right side perspective view of a stationary cross cut system, in accordance with one or more embodiments; the view showing an alignment member inserted into a track of the stationary cross cut system; the view showing the alignment member being used for alignment of a workpiece during a cutting operation; the view showing the workpiece being held in place by a clamp; the view showing a cutting tool guided by guide rails of the stationary cross cut system to facilitate cutting of the workpiece.

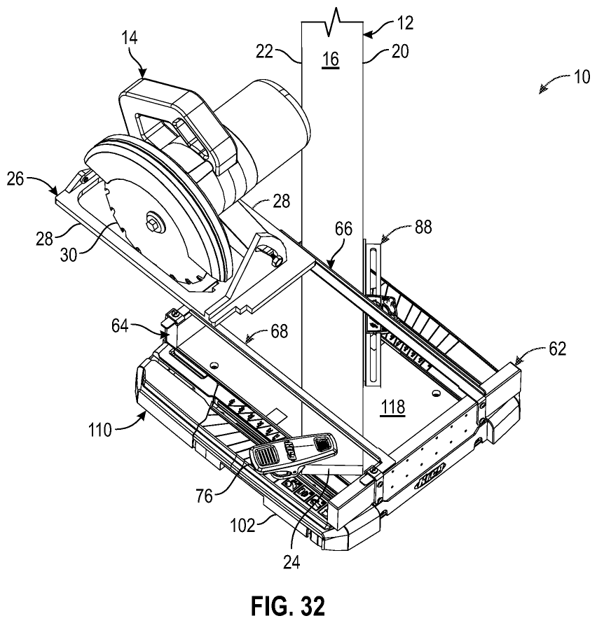

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of use in association with cutting of wood. However, the embodiments are not so limited. Rather, it is contemplated that various disclosed embodiments may be used for cutting of any material including composite, stone, concrete, metal, plastic, or the like or any other material. It is appreciated that the embodiments may be adapted for use in various other reclamation applications, which may be improved by the disclosed structures, arrangements and/or methods. The system is merely shown and described as being used in the context of cutting wood for ease of description and as one of countless examples.

System 10:

In the arrangement shown, as one example, a stationary cross cut system 10 (or simply “system 10”) is presented. Stationary cross cut system 10 is formed of any suitable size, shape and design and is configured to hold a workpiece 12 in a safe and secure manner while guiding a cutting tool 14 to perform a cutting operation in a quick, easy, accurate and safe manner. In the arrangement shown, as one example, stationary cross cut system 10 is used in association with a workpiece 12 having an upper surface 16, a lower surface 18, a front edge 20, a rear edge 22, and opposing ends 24 that is configured to be cut using cutting tool 14 having a baseplate 26 having opposing edges 28 and a blade 30. In the arrangement shown, as one example, stationary cross cut system 10 has a front side 32, a rear side 34, a left side 36, a right side 38, an upper side 40, and a lower side 42. In the arrangement shown, as one example, stationary cross cut system 10 includes a base 44 having a front side 46, a rear side 48, a left side 50, a right side 52, an upper surface 54 and a lower surface 56, an insert 58, a first fence 62, a second fence 64, a first guide rail 66, a second guide rail 68, a track 72, angular indicia 74, a clamp 76 having an upper member 78, a base member 80, a joint 82, an anchor 84 and a bias member 86, an alignment member 88 having an anchor 90, a fence 92, a body 94, fasteners 96 and knobs 98, support wings 100 having arms 102 having an inward end 104, an outward end 106, a pivot point 108 and a support block 110 having an upper surface 112 and a track 114, among other parts, components, systems, features and pieces as is described herein.

Workpiece 12:

In the arrangement shown, as one example, stationary cross cut system 10 is configured to be used in association with a workpiece 12. Workpiece 12 is formed of any suitable size, shape and design.

In the arrangement shown, as one example, workpiece 12 is formed of a generally square or rectangular piece of material having an upper surface 16, a lower surface 18, a front edge 20 (or first edge), a rear edge 22 (or second edge), and opposing ends 24, among other features. As examples, workpiece 12 is formed of a board, a piece of dimensioned lumber, a sheet of plywood, a sheet of medium-density fiberboard (MDF), a piece of trim, a sheet of press board, a sheet of concrete, a sheet of stone, a piece of metal, a sheet of composite material, a sheet of plastic material, a tile, a plate, or the like or any combination thereof, or any other piece of material.

In the arrangement shown, as one example, workpiece 12 is cut by cutting tool 14.

Cutting Tool 14: In the arrangement shown, as one example, stationary cross cut system 10 is configured to be used in association with a cutting tool 14. Cutting tool 14 is formed of any suitable size, shape and design and is configured to facilitate cutting of workpiece 12.

In the arrangement shown, as one example, cutting tool 14 is formed of what is known as a handheld circular saw. However, any other form of a cutting device is hereby contemplated for use as cutting tool 14 including jig saws, reciprocating saws, cutting wheels, or the like.

In the arrangement shown, as one example cutting tool 14 includes a baseplate 26 that has a generally planar bottom surface that is configured to slide over the upper surface 16 of workpiece 12 during a cutting operation. In the arrangement shown, baseplate 26 includes an edge 28, which in the arrangement shown, as one example, is a straight edge, that is configured to slide along guide rail 68 of stationary cross cut system 10 during a cutting operation thereby providing guidance and alignment to cutting tool 14 during a cutting operation. In the arrangement shown, cutting tool 14 includes a blade 30 that is configured to extend through baseplate 26 during operation thereby cutting workpiece 12. In the arrangement, as one example, blade 30 is a circular blade that rotates during operation.

In the arrangement shown, as one example, cutting tool 14 is configured to be used in operation with stationary cross cut system 10.

Orientation:

In the arrangement shown, as one example, stationary cross cut system 10 has a front side 32 and opposing a rear side 34, a left side 36 and opposing right side 38, an upper side 40 and opposing lower side 42.

Base 44:

In the arrangement shown, as one example, stationary cross cut system 10 includes base 44. Base 44 is formed of any suitable size, shape and design and is configured hold workpiece 12 during a cutting operation.

In the arrangement shown, as one example, base 44 is formed of a generally square or rectangular shaped member when viewed from above or below, or when viewed from a side. However, any other shape is hereby contemplated for use.

In the arrangement shown, as one example, base 44 includes a front side 46 and a rear side 48.

In the arrangement shown, as one example, the front side 46 of base 44 is a generally flat and straight surface that extends between opposing outward ends. In the arrangement shown, as one example, rear side 48 of base 44 is a generally flat and straight surface that extends between opposing outward ends. In the arrangement shown, as one example, front side 46 and a rear side 48 extend in approximate parallel spaced planar alignment to one another. However, any other size, shape and configuration is hereby contemplated for use.

In the arrangement shown, as one example, base 44 includes a left side 50 and a right side 52.

In the arrangement shown, as one example, the left side 50 of base 44 is a generally flat and straight surface that extends between opposing forward and rearward ends. In the arrangement shown, as one example, the right side 52 of base 44 is a generally flat and straight surface that extends between opposing forward and rearward ends. In the arrangement shown, as one example, left side 50 and a right side 52extend in approximate parallel spaced planar alignment to one another. However, any other size, shape and configuration is hereby contemplated for use.

In the arrangement shown, as one example, front side 46 and a rear side 48 connect to left side 50 and a right side 52 at corners 116. In the arrangement shown, as one example, front side 46 and a rear side 48 extend in approximate perpendicular alignment to left side 50 and a right side 52. In this way, front side 46 and a rear side 48 and left side 50 and a right side 52 form a generally square or rectangular member when viewed from above or below. However, any other size, shape and configuration is hereby contemplated for use.

In the arrangement shown, as one example, base 44 includes an upper surface 54 and a lower surface 56.

In the arrangement shown, as one example, the upper surface 54 of base 44 forms a generally flat and straight and planar surface that extends between the upper edges of front side 46 and a rear side 48 and left side 50 and a right side 52. In this way, upper surface 54 serves as a generally flat and planar surface that receives the generally flat and planar lower surface 18 of workpiece 12 in flat and flush engagement.

In the arrangement shown, as one example, the lower surface 56 of base 44 forms a generally flat and straight and planar surface that extends between the lower edges of front side 46 and a rear side 48 and left side 50 and a right side 52. In this way, lower surface 56 serves as a generally flat and planar surface that rests upon a generally flat work surface such as a benchtop, the floor or any other surface. In this way, lower surface 56 forms a generally stable surface or foundation for base 44 to rest upon. With that said, lower surface 56 is formed of a plurality of structural members that extend across lower surface 56 that provide structural strength and integrity to base 44. As such, lower surface 56 is formed of the lower edge of these structural members that collectively form a generally flat plane that forms lower surface 56.

In the arrangement shown, as one example, upper surface 54 and a lower surface 56 extend in approximate parallel spaced planar alignment to one another. In the arrangement shown, as one example, upper surface 54 and a lower surface 56 extend in approximate perpendicular planar alignment to front side 46 and a rear side 48. In the arrangement shown, as one example, upper surface 54 and lower surface 56 extend in approximate perpendicular planar alignment to left side 50 and a right side 52. In this way, front side 46 and a rear side 48 and left side 50 and a right side 52 and upper surface 54 and lower surface 56 form a generally square or rectangular member when viewed from above or below or a side. However, any other size, shape and configuration is hereby contemplated for use.

Insert 58:

In the arrangement shown, as one example, stationary cross cut system 10 includes an insert 58. Insert 58 is formed of any suitable size, shape and design and is configured to support workpiece 12 while also being a consumable or sacrificial member or part of stationary cross cut system 10 that can be quickly and easily replaced.

That is, stationary cross cut system 10 is configured to hold a workpiece 12 during a cutting operation by cutting tool 14. During this cutting operation, blade 30 of cutting tool 14 cuts through workpiece 12 a slight distance. Insert 58 is configured to receive the portion of blade 30 of cutting tool 14 that extends through workpiece 12. In this way, insert 58 is slightly cut during a cutting operation as well. Insert 58 is quickly and easily replaced.

In the arrangement shown, as one example, insert 58 is formed of a piece of consumable material such as a piece of MDF (medium-density fiberboard), a piece of plywood, a piece of dimension lumber, a piece of plastic material, a piece of composite material, a piece of UFMW material or a piece of any other form of material. In the arrangement shown, as one example, insert 58 is generally square or rectangular in shape. In the arrangement shown, as one example, insert 58 includes opposing generally flat and planar upper and lower surfaces 118 that extend in approximate parallel planar spaced relation to one another. In the arrangement shown, as one example, insert 58 includes opposing generally flat and planar forward and rearward surfaces 120 that extend in approximate parallel planar spaced relation to one another. In the arrangement shown, as one example, insert 58 includes opposing generally flat and planar side surfaces 122 that extend in approximate parallel planar spaced relation to one another.

In the arrangement shown, as one example, opposing generally flat and planar forward and rearward surfaces 120 that extend in approximate perpendicular planar spaced relation to opposing generally flat and planar side surfaces 122 thereby forming a generally square or rectangular member when viewed from above or below.

In the arrangement shown, as one example, opposing generally flat and planar upper and lower surfaces 118 extend in approximate perpendicular planar spaced relation to opposing generally flat and planar forward and rearward surfaces 120. In the arrangement shown, as one example, opposing generally flat and planar upper and lower surfaces 118 extend in approximate perpendicular planar spaced relation to opposing generally flat and planar side surfaces 122 thereby forming a generally square or rectangular member when viewed from a side.

In the arrangement shown, as one example, insert 58 is configured to fit within recess 124 in the upper surface 54 of base 44. In the arrangement shown, as one example, when insert 58 is positioned within recess 124, the sides surfaces 122 of insert 58 are positioned in parallel spaced alignment with the sides of recess 124, and the upper surface 118 of recess 124 is positioned in approximate parallel planar alignment to the upper surface 54 of base 44. In this way, the combined upper surface 54 of base 44 and the upper surface 118 of insert 58 forms a generally flat and planar surface for workpiece 12 to rest upon during a cutting operation. In an alternative arrangement, the upper surface 118 of insert 58 rises above the upper surface 54 of base 44 just slightly so as to ensure that the upper surface 54 of base 44 does not interfere with a flat and flush and secure engagement between workpiece 12 and the upper surface 118 of insert 58.

In the arrangement shown, as one example, recess 124 extends to the front side 46 and rear side 48 of base 44. Or, said another way, the forward and rearward surfaces 120 of insert 58 are at or near the front side 46 and rear side 48 of base 44. In this way, blade 30 of cutting tool 14 does not engage base 44 at the beginning or end of the cutting operation. Instead, blade 30 of cutting tool 14 only engages insert 58 (as well as first fence 62 and second fence 64 as is further described herein). In this way, the upper surface 118 of insert 58 supports the lower surface 18 of workpiece 12 during a cutting operation thereby helping to reduce tear-out and thereby providing cleaner cuts.

In the arrangement shown, as one example, insert 58 is generally centrally positioned between opposing left side 50 and right side 52 of base 44.

In the arrangement shown, as one example, insert 58 is fastened into base 44 by a plurality of fasteners 126 that are received within holes in the upper surface 118 of base 44. In the arrangement shown, as one example, four fasteners 126 are used, with one fastener 126 positioned adjacent each corner of insert 58. Fasteners 126 are formed of any fastening devices such as screws, bolts, snap fit features or the like.

First Fence 62 & Second Fence 64:

In the arrangement shown, as one example, stationary cross cut system 10 includes a first fence 62 and a second fence 64. First fence 62 and second fence 64 are formed of any suitable size, shape and design and is configured to retain and align workpiece 12 as well as support first guide rail 66 and second guide rail 68. First fence 62 and second fence 64 are also configured to allow the passage of blade 30 of cutting tool 14 to pass there through and in this way first fence 62 and second fence 64 are sacrificial in nature.

In the arrangement shown, as one example, first fence 62 and a second fence 64 are generally similar or identical shaped members, albeit second fence 64 being narrower in length than first fence 62. In the arrangement shown, as one example, first fence 62 is positioned adjacent the front side 46 of base 44 and second fence 64 is positioned adjacent the rear side of base 44. In the arrangement shown, as one example, first fence 62 extends approximately the entire left side 36 to right side 38 width of base 44, whereas, second fence 64 extends approximately the width of insert 58 of base 44. Any other size, shape and configuration is hereby contemplated for use.

In the arrangement shown, as one example, first fence 62 and a second fence 64, like insert 58, are formed of a piece of consumable material such as a piece of MDF (medium-density fiberboard), a piece of plywood, a piece of dimension lumber, a piece of plastic material, a piece of composite material, a piece of UFMW material or a piece of any other form of material. In the arrangement shown, as one example, first fence 62 and a second fence 64 are generally square or rectangular in shape. In the arrangement shown, as one example, first fence 62 and a second fence 64 include opposing generally flat and planar upper and lower surfaces 128 that extend in approximate parallel planar spaced relation to one another. In the arrangement shown, as one example, first fence 62 and a second fence 64 include opposing generally flat and planar forward and rearward surfaces 130 that extend in approximate parallel planar spaced relation to one another. In the arrangement shown, as one example, first fence 62 and a second fence 64 include opposing generally flat and planar side surfaces 132 that extend in approximate parallel planar spaced relation to one another.

In the arrangement shown, as one example, opposing generally flat and planar forward and rearward surfaces 130 that extend in approximate perpendicular planar spaced relation to opposing generally flat and planar side surfaces 132 thereby forming a generally square or rectangular member when viewed from above or below.

In the arrangement shown, as one example, opposing generally flat and planar upper and lower surfaces 128 extend in approximate perpendicular planar spaced relation to opposing generally flat and planar forward and rearward surfaces 130. In the arrangement shown, as one example, opposing generally flat and planar upper and lower surfaces 128 extend in approximate perpendicular planar spaced relation to opposing generally flat and planar side surfaces 132 thereby forming a generally square or rectangular member when viewed from a side.

In the arrangement shown, as one example, first fence 62 is connected adjacent the front side 46 of base 44 and the second fence 64 is connected adjacent the rear side 48 of base 44. In the arrangement shown, as one example, first fence 62 extends in approximate parallel spaced relation to the front side 46 of base 44 and forward surface 120 of insert 58 and the second fence 64 extends in approximate parallel spaced relation to the rear side 48 of base 44 and rear surface 120 of insert 58.

In the arrangement shown, as one example, the interior facing surfaces 130 of first fence 62 and second fence 64 extend upward a distance from the upper surface 118 of insert 58 in a generally perpendicular planar manner before terminating in upper surface 128. In the arrangement shown, as one example, the exterior facing surfaces 130 of first fence 62 and second fence 64 include a plurality of holes 134. In the arrangement shown, as one example, these holes 134 are formed of a plurality of laterally spaced pairs of vertically spaced holes 134.

First fence 62 and second fence 64, and holes 134, are configured to receive first guide rail 66 and second guide rail 68.

First Guide Rail 66 and Second Guide Rail 68:

In the arrangement shown, as one example, stationary cross cut system 10 includes a first guide rail 66 and a second guide rail 68. First guide rail 66 and a second guide rail 68 are formed of any suitable size, shape and design and is configured to receive, align and guide baseplate 26 of cutting tool 14 during the performance of a cutting operation.

First Guide Rail 66: In the arrangement shown, as one example, first guide rail 66 is what is known as a fixed guide rail in that first guide rail 66 may be attached to a pair of holes 134 in first fence 62 and second fence 64 but may not be adjusted beyond the selection of which holes 134 to attach first guide rail 66 to. In the arrangement shown, as one example, first guide rail 66 is formed of an elongated rectangular member that extends a length between opposing ends 136 in a generally flat and straight manner. In the arrangement shown, as one example, first guide rail 66 bends downward at a corner 138 before terminating at ends 136. These downward extending portions of first guide rail 66 are configured to fit over and engage the exterior facing surfaces 130 of first fence 62 and second fence 64 with close and tight tolerances and flat and flush engagement. To accomplish this, the corners 138 of first guide rail 66 are positioned at the intersection of the upper surface 128 and outward facing surface 130 of first fence 62 and second fence 64.

In the arrangement shown, as one example, first guide rail 66 forms a generally planar upper surface 140 that extends in a generally flat and straight manner between opposing corners 138. In the arrangement shown, as one example, first guide rail 66 also includes a flange 142 that extends upward at the outward side of first guide rail 66 between opposing corners 138. In the arrangement shown, as one example, the plane formed by upper surface 140 extends in approximate perpendicular planar alignment to the plane formed by the interior facing surface of flange 142. In this way, the upper surface 140 of first guide rail 66 is configured to receive the lower surface of baseplate 26 of cutting tool 14 and the interior facing surface of flange 142 is configured to receive an edge 28 of baseplate 26 of cutting tool 14, thereby aligning and guiding baseplate 26 of cutting tool 14 during a cutting operation.

In the arrangement shown, as one example, first guide rail 66 is installed by placing the inward facing surfaces of the downwardly extending portions of first guide rail 66 over the exterior facing surfaces 130 of first fence 62 and second fence 64. These downwardly extending portions of first guide rail 66 include a pair of holes that are configured to match holes 134 in the exterior facing surfaces 130 of first fence 62 and second fence 64. The user selects the desired pair of holes 134 and fasteners 144, which are any form of fastener such as a screw, bold, snap fit feature or the like, are inserted through first guide rail 66 and into exterior facing surfaces 130 of first fence 62 and second fence 64 thereby affixing first guide rail 66 to first fence 62 and second fence 64. In this position, the lower surface of first guide rail 66, just inward of corners 138 is in flat and flush engagement with the upper surface 128 of first fence 62 and second fence 64. In this way, first guide rail 66 is securely held in place on first fence 62 and second fence 64.

Second Guide Rail 68: In the arrangement shown, as one example, second guide rail 68 is what is known as an adjustable guide rail in that second guide rail 68 may be attached to a pair of holes 134 in first fence 62 and second fence 64 and after the selection of which holes 134 to attach second guide rail 68 to the second guide rail 68 may be infinitely finely adjusted.

In the arrangement shown, as one example, second guide rail 68 is formed of an elongated rectangular member that extends a length between opposing ends 136 in a generally flat and straight manner. Instead of bending downward, like first guide rail 66, second guide rail 68 extends rearward of flange 142 a distance before terminating in ends 146.

In the arrangement shown, as one example, second guide rail 68 forms a generally planar upper surface 140 that extends in a generally flat and straight manner between opposing ends 136. In the arrangement shown, as one example, second guide rail 68 also includes a flange 142 that extends upward at the outward side of second guide rail 68 between opposing ends 136. In the arrangement shown, as one example, the plane formed by upper surface 140 extends in approximate perpendicular planar alignment to the plane formed by the interior facing surface of flange 142. In this way, the upper surface 140 of second guide rail 68 is configured to receive the lower surface of baseplate 26 of cutting tool 14 and the interior facing surface of flange 142 is configured to receive an edge 28 of baseplate 26 of cutting tool 14, thereby aligning and guiding baseplate 26 of cutting tool 14 during a cutting operation.

In the arrangement shown, as one example, second guide rail 68 also includes a pair of brackets 148. Brackets 148 are formed of any suitable size, shape and design and are configured to attach the upper portion of second guide rail 68 to first fence 62 and second fence 64 in a secure manner while allowing for infinite fine adjustment.

In the arrangement shown, as one example, brackets 148 are formed of a J-shaped, a U-shaped, a C-shaped or other shaped member. In the arrangement shown, as one example, brackets 148 are configured to extend along the exterior facing surfaces 130 of first fence 62 and second fence 64, over the upward facing surfaces 128 of first fence 62 and second fence 64 and down a portion of the inward facing surfaces 130 of first fence 62 and second fence 64 in generally flat and flush engagement with close and tight tolerances. Brackets 148 are also configured to extend over a portion of second guide rail 68 which is rearward of flange 142 and forward of end 146. In this way, the J-shaped, a U-shaped, a C-shaped or other shaped member of bracket 148 traps second guide rail 68 to fence 62 and second fence 64.

In the arrangement shown, as one example, brackets 148 include an exterior portion 150 that extend along the exterior facing surfaces 130 of first fence 62 and second fence 64, an upper portion 152 that extends over the upward facing surfaces 128 of first fence 62 and second fence 64 as well as over a portion of second guide rail 68, and an inward portion 154 that extend along the interior facing surfaces 130 of first fence 62 and second fence 64 a distance before terminating. In the arrangement shown, as one example, exterior portions 150 of brackets 148 include a pair of holes that are configured to match holes 134 in exterior facing surfaces 130 of first fence 62 and second fence 64.

In the arrangement shown, as one example, second guide rail 68 is installed by placing the second guide rail 68 on the upper surface 128 of first fence 62 and second fence 64 in the desired position. Next, brackets 148 are placed over the second guide rail 68 just rearward of flange 142 and forward of end 146 as well as over first fence 62 and second fence 64. Next, holes in exterior portion 150 of brackets 148 are aligned with a desired set of holes 134 in the exterior facing surfaces 130 of first fence 62 and second fence 64. Next, fasteners 144, which are any form of fastener such as a screw, bold, snap fit feature or the like, are inserted through the holes in exterior portion 150 of brackets 148 and into exterior facing surfaces 130 of first fence 62 and second fence 64 thereby affixing bracket 148 to first fence 62 and second fence 64.

Next, the position of second guide rail 68 is finely adjusted by laterally sliding second guide rail 68 to the desired position. Once second guide rail 68 is in the desired position, second guide rail 68 is locked in place using lock member 156. Lock member 156 is formed of any suitable size, shape and design and is configured to lock second guide rail 68 in place. In the arrangement shown, as one example, lock member 156 is a lock screw that extends through the upper portion 152 of bracket 148 and engages the upper surface 140 of second guide rail 68 rearward of flange 142 and forward of end 146. In this way, when lock member 156 is tightened the position of second guide rail 68 is locked in place. Any other form of an adjustment and locking member is hereby contemplated for use as lock member 156.

In this way, second guide rail 68 is securely held in place on first fence 62 and second fence 64 while also being finely and infinitely adjustable so as to fit any sized baseplate 26 of any cutting tool 14

Track 72 (and Track 114):

In the arrangement shown, as one example, stationary cross cut system 10 includes a pair of tracks 72. Tracks 72 are formed of any suitable size, shape and design and are configured to facilitate connection of various tools and accessories to stationary cross cut system 10, such as clamp 76.

In the arrangement shown, as one example, track 72 is formed of a T-shaped track or slot that is positioned in the upper surface 54 of base 44. In the arrangement shown, as one example, a track 72 is positioned in the upper surface 54 of base 44 between the side surfaces 122 of insert 58 and the side 50, 52 of base 44. In the arrangement shown, as one example, tracks 72 run in approximate parallel alignment with sides 50, 52 of base 44, and in approximate perpendicular alignment with the front side 46 and rear side 48 of base 44. In the arrangement shown, as one example, tracks 72 include a metallic insert that is placed within a slot in the upper surface 54 of base 44 that is formed of a plastic, nylon, fiberglass, composite or other non-metallic material. This metallic insert provides increased strength, durability and long life to tracks 72.

In the arrangement shown, as one example, the forward end of tracks 72 are positioned at approximately the inward facing surface 130 of first fence 62. In the arrangement shown, as one example, the rearward end 160 of tracks 72 are positioned at the rearward edge 161 of base 44, just before the forward edge of support block 110 of support wings 100. In this way, the rearward end 160 of track 72 provides access into, and an exit out of, track 72.

In the arrangement show, as one example, the rearward end 160 of track 72 aligns with the forward end 162 of track 114 in the upper surface 112 of support block 110, when support wing 100 is in a retracted position. In this way, when support wing 100 is in a retracted position, track 72 of base 44 aligns with track 114 in support block 110 thereby forming a single continuous elongated track formed of track 72 and track 114.

In the arrangement shown, as one example, track 114 in the upper surface 112 of support block 110 extends a length from forward end 162 to rearward end 164.

In the arrangement shown, as one example, forward end 162 of track 114 intersects with the forward edge 166 of support block 110. In this way, the forward end 162 of track 114 provides access into and an exit out of track 114. When support block 110 is in a retracted position, this forward end 162 of track 114 aligns with and provides access into and out of the rearward end 160 of track 72 of base 44.

In the arrangement shown, as one example, rearward end 164 of track 114 intersects with the rearward edge 168 of support block 110. In this way, the rearward end 164 of track 114 provides access into and an exit out of track 114 which eventually leads to access into and an exit out of track 72 of base 44.

In the arrangement shown, as one example, a track 72 and a track 114 is positioned at each side 50, 52 of base 44. This allows for the insertion of clamps 76 and alignment members 88 for clamping and/or alignment of workpiece 12 on either or both sides 50, 52 of base 44.

Angular Indicia 74:

In the arrangement shown, as one example, stationary cross cut system 10 includes angular indicia 74. Angular indicia 74 is formed of any suitable size, shape and design and is configured to facilitate angular cuts of workpiece 12 by providing a visual indication of an angle of a cutting operation.

In the arrangement shown, as one example, angular indicia 74 is formed of a plurality of markings in the upper surface 54 of base 44 that provides a visual indication of an angle of a cutting operation. In the arrangement shown, as one example, angular indicia 74 are positioned on both sides of track 72 in the upper surface 54 of base 44. More specifically, as one example, as is shown, angular indicia 74 are formed of a plurality of lines that extend between the exterior side surfaces 122 of insert 58 to the exterior sides 50, 52 of base. In this way, each line extends the maximum length along the upper surface 54 of base 44 thereby providing maximum alignment. In the arrangement shown, as one example, each line has a marking that identifies the angle of cut that the particular line indicates. As examples, these markings include 5°, 10°, 15°, 20°, 25°, 30°, 35°, 40° and 45°, however any other angle is hereby contemplated for use.

Angular indicia 74 may be used by aligning an edge 20, 22 of workpiece 12 directly with the line and then holding or clamping the workpiece 12 in place to perform a cutting operation at that particular angle. Alternatively, angular indicia 74 may be used to align a fence 92 of an alignment member 88 that is connected to track 72/114 of base 44 that is used to align an edge 20, 22 of workpiece 12.

Any other form of angular indicia 74, or any other form of indicia, is hereby contemplated for use on upper surface 54 of base 44, or any other portion of base 44.

Clamp 76:

In the arrangement shown, as one example, stationary cross cut system 10 includes at least one clamp 76. Clamp 76 is formed of any suitable size, shape and design and is configured to facilitate clamping of workpiece 12 during a cutting operation thereby holding workpiece 12 in a secure manner so as to facilitate safe as well as cutting of workpiece 12.

In the arrangement shown, as one example, clamp 76 includes an upper member 78 and a base 80 that connect together at a joint 82. Joint 82 allows upper member 78 and base 80 to move relative to one another so as to allow upper member 78 to reach over and engage the upper surface 16 of workpiece 12 and clamp workpiece 12 to the upper surface 54 of base 44 as well as the upper surface 118 of insert 58.

In the arrangement shown, as one example, upper member 78 extends a length between a forward end 170 and a rearward end 172 a joint 82 is formed of a pivot point between upper member 78 and base 80. In the arrangement shown, as one example, joint 82 includes an axle or bearing between upper member 78 and a base 80. In the arrangement shown, as one example, clamp 76 includes a bias member 86 (not particularly well shown) that is positioned between and/or engages upper member 78 and a base 80 and applies a bias force that forces the forward end 170 of clamp 76 downward thereby applying a clamping force onto workpiece 12 when forward end 170 of clamp 76 is placed on upper surface 16 of workpiece 12. In the arrangement shown, as one example, bias member 86 is a spring member that forces the forward end 170 of clamp 76 toward base 80.

In the arrangement shown, as one example, forward end 170 of upper member 78 of clamp 76 extends forward a distance from the pivot point of joint 82. Similarly, in the arrangement shown, as one example, rearward end 172 of upper member 78 of clamp 76 extends rearward a distance from the pivot point of joint 82. In this way, a moment or leverage is created thereby allowing a user to apply pressure to the rearward end 172 of upper member 78 of clamp 76 to open the clamp 76 to facilitate the insertion of workpiece 12 thereunder, while also allowing bias member 86 to apply a clamping force on workpiece 12 when the user releases the rearward end 172 of upper member 78 of clamp 76.

In the arrangement shown, as one example, the lower surface 174 of base member 80 of clamp 76 is generally flat and is configured to slide over and engage the upper surface 54 of base 44 in a flat and flush manner. In the arrangement shown, an anchor 84 extends out of the lower surface 174 of base member 80 in a generally perpendicular manner.

Anchor 84 is formed of any suitable size, shape and design and is configured to be inserted within track 72, 114 of base 44, support block 110 and facilitate sliding adjustment while also allowing for easy clamping in place along track 72, 114. In the arrangement shown, as one example, anchor 84 is formed of a circular member that is fastened to the lower surface 174 of base member 80 with a fastener. In the arrangement shown, as one example, anchor 84 has a similarly shaped T-shaped profile as track 72, 114 which allows forward-to-back sliding as well as prevents vertical pull-out.

Any form of a clamping member is hereby contemplated for use as clamp 76.

Alignment Member 88:

In the arrangement shown, as one example, stationary cross cut system 10 includes at least one alignment member 88. Alignment member 88 is formed of any suitable size, shape and design and is configured to facilitate alignment of workpiece 12 during a cutting operation at various angles in a safe, secure and accurate manner.

In the arrangement shown, as one example, alignment member 88 includes an anchor 90, a fence 92, a body 94, fasteners 96 and knobs 98.

Anchor 90 is formed of any suitable size, shape and design and is configured to be inserted within track 72, 114 of base 44, support block 110 and facilitate sliding adjustment while also allowing for easy clamping/locking in place along track 72, 114. In the arrangement shown, as one example, anchor 90 is formed of an elongated member that is fastened to fence 92 and body 94 with fasteners 96 and knobs 98. In the arrangement shown, as one example, anchor 90 with fasteners 96 form a similar T-shaped profile as track 72, 114 which allows forward-to-back sliding as well as prevents vertical pull-out. In the arrangement shown, as one example, anchor 90 has a hole 176 adjacent its forward end and rearward end that receive fasteners 96 therein.

Fence 92 is formed of any suitable size, shape and design and is configured to engage and provide alignment to workpiece 12 so as to form accurate angled cuts anywhere from 0° (or perpendicular) to 45°. In the arrangement shown, as one example, fence 92 is formed of an elongated member that extends a length between opposing ends 178 that is fastened to anchor 90 and body 94. In the arrangement shown, fence 92 is a formed of a generally flat elongated member that includes a slot 180 therein and a flange 182 that extends upward therefrom in a generally perpendicular planar manner to the main body of fence 92. In the arrangement shown, as one example, one of the fasteners 96 extends through anchor 90, slot 180 of fence 92 as well as through body 94. In the arrangement shown, as one example, the other fastener 96 only extends through anchor 90 and body 94.

Body 94 is formed of any suitable size, shape and design and is configured to engage fence 92 and anchor 90 and provide angular alignment to fence 92 so as to form accurate angled cuts anywhere from 0° (or perpendicular) to 45°. In the arrangement shown, as one example, body 94 is formed of member that receives both fasteners through openings in body 94. Body 94 includes a hole 184 that receives a fastener 96 that extends through anchor 90 as well as through slot 180 of fence 92. Body also includes a slot 186 that receives a fastener 96 that extends through anchor 90 only and does not extend through slot 180 of fence 92. This slot 186 is curved and facilitates angular alignment of fence 92 relative to body 94.

Fasteners 96 and knobs 98 are formed of any suitable size, shape and design and is configured to facilitate selective loosening and tightening of anchor 90, fence 92 and/or body 94. In the arrangement shown, as one example, fasteners 96 are conventional screws or bolts, however any other fastening member is hereby contemplated for use. In the arrangement shown, as one example, knobs 98 are formed of any member that can be used to loosen or tighten fasteners 96 to anchor 90, fence 92 and/or body 94. In the arrangement shown, as one example, knobs 98 are laterally elongated T-shaped knobs so as to facilitate easy hand-tightening and hand-loosening.

In the arrangement shown, as one example, alignment member 88 is attached to base 44 by inserting anchor 90 into track 72, 114. Once anchor 90 is inserted into track 72, 114, alignment member 88 is slid to the desired location along track 72, 114. Once anchor 90 is in the desired location, fence 92 is aligned to the desired angular alignment. This may be accomplished by rotating fence 92 and body 94 relative to anchor 90. The desired angle may be accomplished by referring to the markings on the body 94 itself and/or by aligning fence 92 with angular indicia 74 of base 44. Once the desired forward-to-back location is achieved and the desired angular alignment is achieved, knobs 98 are tightened which tightens anchor 90, fence 92 and body 94 to track 72, 114 thereby locking both the forward-to-back location as well as the desired angular alignment. Once locked in this manner, a workpiece 12 may be slid against an edge of fence 92 which provides angular alignment to workpiece 12. In addition, once slid against an edge of fence 92, workpiece can be clamped in place using clamp 76.

It is to be noted, that a clamp 76 and an alignment member 88 may be inserted in either track 72, 114 on either side of base 44 thereby providing angular alignment and clamping of a workpiece 12 in multiple ways. This provides a flexible, versatile and easy to use alignment and clamping system for a wide variety of cutting operations for workpieces 12.

Any form of a clamping member is hereby contemplated for use as alignment member 88.

Support Wings 100:

In the arrangement shown, as one example, stationary cross cut system 10 includes a pair of support wings 100. Support wings 100 are formed of any suitable size, shape and design and are configured to move between a retracted position and an extended position so as to support elongated workpieces 12. In the arrangement shown, a support wing 100 is connected to each side 50, 52 of base 44.

In the arrangement shown, as one example support wings 100 include arms 102. Arms are formed of any suitable size, shape and design and are configured to attach support blocks 110 to base 44 while also facilitating the angular extension of support blocks 110 outward from base 44 as well as facilitating the removal of support blocks 110 from arms 102. In the arrangement shown, as one example, arms 102 are generally rectangular shaped members that extend a length from inward end 104 to outward end 106.

In the arrangement shown, as one example, inward end 104 of arms 102 connect to base 44 at pivot point 108. In the arrangement shown, as one example, pivot point 108 is formed by a fastener extending through the inward end 104 of arm 102 and into the lower surface 56 of base 44 thereby forming an axis upon which arm 102 may pivot between a fully extended position and a fully retracted position. Arms 102 may be infinitely adjustable between a fully retracted position, wherein arms 102 are adjacent and in approximate parallel spaced alignment to sides 50, 52 of base 44, and a fully extended position, wherein arms 102 extend outward from sides 50, 52 in an approximate perpendicular alignment to sides 50, 52.

In the arrangement shown, as one example, the outward end of arms 102 connect to support blocks 110. Support blocks 110 are formed of any suitable size, shape and design and are configured to support workpiece 12 when in a fully retracted position, wherein support blocks 110 are adjacent the sides 50, 52 of base 44, when in an extended position, wherein arms 102 extend outward from sides 50, 52 in an approximate perpendicular alignment to sides 50, 52, as well as when in a remote position, wherein support blocks 110 are removed from the outward ends 106 of arms 102.

In the arrangement shown, as one example, support blocks 110 have an upper surface 112 that is generally flat and planar and is in approximate planar alignment with the upper surface 54 of base 44. As such, a workpiece 12 in engagement with upper surface 54 of base 44 is similarly in engagement with upper surface 112 of support block 110, regardless of if support block 110 is in a retracted position, an extended position or a remote position.

In the arrangement shown, as one example, support block 110 extends a forward-to-back length between forward end 162 and rearward end 164. In the arrangement shown, as one example, support block 110 extends a lateral width between an interior side 188 and an exterior side 190. When support wing 100 is in a retracted position, support block 110 nests within base 44.

That is, in the arrangement shown, as one example, when support wing 100 is in a retracted position, the forward edge 166 of support block 110 is in flat and flush engagement with the rearward edge 161 of base 44, the interior side 188 of support block 110 is in flat and flush engagement with side surface 192 of base 44, the exterior side 190 of support block 110 is in approximate flush or parallel planar alignment with the side 50, 52 of base 44, and the rearward edge 168 of support block 110 is in approximate flush or parallel planar alignment with rear side 48 of base 44.

In the arrangement shown, as one example, to facilitate locking in a retracted position, side surface 192 of base 44 includes a catch member 194 that engages a slot 196 in support block 110 thereby locking support block 110 in a retracted position. It is hereby contemplated that the orientation of the catch member 194 and slot 196 may be reversed. It is hereby contemplated that any other mechanism and or method of holding two components together may be used to hold support block 110 in a retracted position, such as magnetic members, catches, latches, brackets, hook-and-loop members, adhesives, or the like.

In the arrangement shown, as one example, to facilitate easy extension of support block 110 from a retracted position to an extended position, a recess 198 is positioned at the intersection of the upper surface 112 and interior side 188 of support block 110. To move the support block 110 from a retracted position to an extended position, a user places their fingers in the recess 198 in the interior side 188 of support block 110 and presses outward. Once enough force is applied that overcomes the force of engagement between catch member 194 and slot 196 support wing 100 pivots upon pivot point 108 and support block 110 moves outward. The user then may move support wing 100 outward to any angular position between fully retracted and fully extended, or perpendicular.

If workpiece 12 is elongated, and support is needed farther outward from base 44 than the length of arm 102, support block 110 may be quickly and easily removed from arm 102 by pulling upward on support block 110. Once support block 110 is separated from the outward end 106 of arm 102, support block 110 may be placed at any position. As support block 110 has approximately the same height as the upper surface 54 of base 44, support block 110 may be placed under workpiece 12 thereby keeping workpiece 12 flat and level which makes for quicker, easier, safer and more accurate cuts.

In the arrangement shown, as one example, support block 110 includes a track 114 in its upper surface 112. In the arrangement shown, as one example, track 114 in the upper surface 112 of support block 110 extends a length from forward end 162 to rearward end 164.

In the arrangement shown, as one example, forward end 162 of track 114 intersects with the forward edge 166 of support block 110. In this way, the forward end 162 of track 114 provides access into, and an exit out of, track 114. When support block 110 is in a retracted position, against side surface 192 of base 44, this forward end 162 of track 114 aligns with and provides access into and out of the rearward end 160 of track 72 of base 44.

In the arrangement shown, as one example, rearward end 164 of track 114 intersects with the rearward edge 168 of support block 110. In this way, the rearward end 164 of track 114 provides access into and an exit out of track 114 which eventually leads to access into and an exit out of track 72 of base 44.

In the arrangement shown, as one example, a track 72 and a track 114 is positioned at each side 50, 52 of base 44. This allows for the insertion of clamps 76 and alignment members 88 for clamping and/or alignment of workpiece 12 on either or both sides 50, 52 of base 44.

Feet 200:

In the arrangement shown, as one example, stationary cross cut system 10 includes feet 200. Feet 200 are formed of any suitable size, shape and design and are configured to provides some cushion to base 44 as well as to prevent base 44 from slipping during use. In the arrangement shown, as one example, lower surface 56 include a plurality of feet 200 that are placed in spaced relation to one another. In one arrangement, feet are formed of a semi-compressible material such as a rubber or plastic or synthetic rubber or other material that has a high coefficient of friction, so as to reduce slippage, as well as some vibrational absorption properties so as to reduce vibrations during use. In one arrangement one or more feet 200 are also placed in the lower surface of support blocks 110 so that support blocks 110 when removed from base 44 have similar properties as base 44.

In Operation:

In operation, stationary cross cut system 10 is set up for a particular cutting tool 14 by attaching first guide rail 66 to first fence 62 and second fence 64 to first fence 62 and second fence 64 at the desired distance apart from one another based on the edge 28 to edge 28 width of baseplate 26. This is accomplished by selecting the appropriate holes 134 in first fence 62 and second fence 64 and fastening first guide rail 66 to first fence 62 and second fence 64 using fasteners 144. Similarly, this is accomplished by selecting the appropriate holes 134 in first fence 62 and second fence 64 and fastening second guide rail 68 to first fence 62 and second fence 64 using fasteners 144. Second guide rail 68 is finely adjusted by sliding guide rail 68 laterally under the upper portion 152 of bracket 148 until the desired finely-adjusted location is achieved. Once in the appropriate finely-adjusted location is achieved, lock member 156 is tightened thereby locking second guide rail 68 in the calibrated or adjusted position for cutting tool 14. First guide rail 66 and second guide rail 68 are appropriately adjusted when the edges 28 of baseplate 26 of cutting tool 14 are aligned with the inward facing surfaces of flanges 142 of first guide rail 66 and second guide rail 68. In this arrangement, first guide rail 66 and second guide rail 68 provide precise alignment to cutting tool 14 during a cutting operation. It is desired that cutting tool 14 is centered upon base 44. The adjustments of the first guide rail 66 and second guide rail 68 allow a user to center cutting tool 14 upon base 44.

Now that the stationary cross cut system 10 is calibrated or adjusted for use with cutting tool 14, a workpiece 12 is placed on the upper surface 54 of base 44 as well as the upper surface 118 of insert 58. This is accomplished by inserting an end 24 of workpiece 12 under first guide rail 66 and second guide rail 68 between first fence 62 and second fence 64.

Example Perpendicular Cut: When cutting a perpendicular cut, the front edge 20 of workpiece 12 may be placed against the rearward facing surface 130 of first fence 62. Once in this position, a clamp 76 may be inserted into track 114 of support blocks 110 and/or into track 72 in base 44. Once clamp 76 is placed in the desired position, clamp 76 is used to clamp workpiece 12 in place which secures workpiece 12 during a cutting operation.

To perform a cutting operation, baseplate 26 of cutting tool 14 is placed on the upper surfaces 140 of first guide rail 66 and second guide rail 68 with the edges 28 of baseplate 26 of cutting tool 14 aligned with the inward facing surfaces of flanges 142 of first guide rail 66 and second guide rail 68. Once in this position, cutting tool 14 is powered and slid forward on the upper surfaces 140 of first guide rail 66 and second guide rail 68 while baseplate 26 is guided by the inward facing surfaces of flanges 142 of first guide rail 66 and second guide rail 68.

As cutting tool 14 moves forward, blade 30 cuts through the sacrificial second fence 64 first. As the cutting tool 14 moves forward, blade 30 cuts slightly into the upper surface 118 of insert 58. This continues until blade 30 engages the rear edge 22 of workpiece 12 at which point blade 30 begins cutting workpiece 12. As workpiece 12 is cut, the sacrificial insert 58 supports the edges of lower surface 18 of workpiece 12 adjacent to the cut thereby reducing tear out and chipping. This reduction in tear out and chipping is accomplished by having the blade 30 matched to the insert 58.

This cutting continues until blade 30 engages the sacrificial first fence 64. As blade 30 continues moving forward, blade 30 exits second fence 64, insert 58, workpiece 12 and first fence 62 at which point the cutting operation is complete.

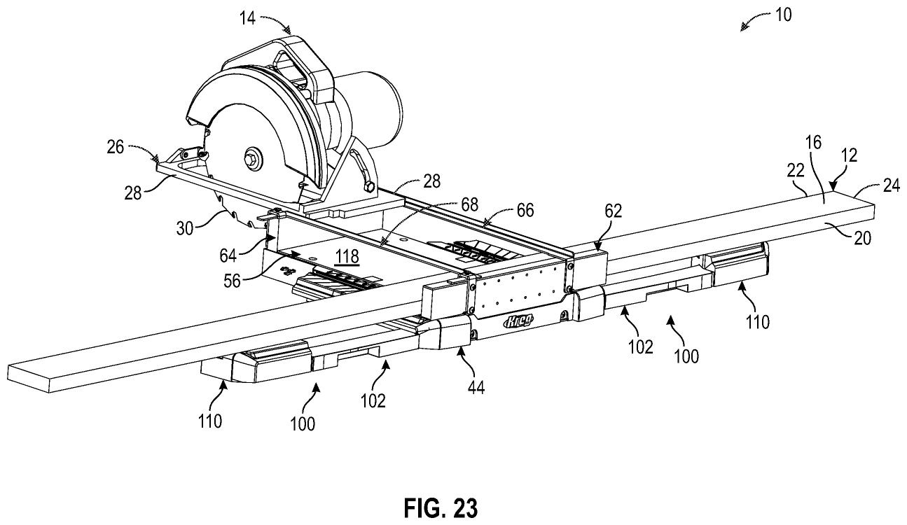

When workpiece 12 is longer than base 44, support wings 100 may be extended outward. When support wings 100 are extended outward, the upper surface 112 of support blocks 110 engage the lower surface 18 of workpiece 12 thereby stabilizing workpiece 12 and facilitating a safer and more accurate cut as workpiece 12 has been stabilized and is not inclined to move during or after a cut. This arrangement is shown as one example, in FIG. 23.

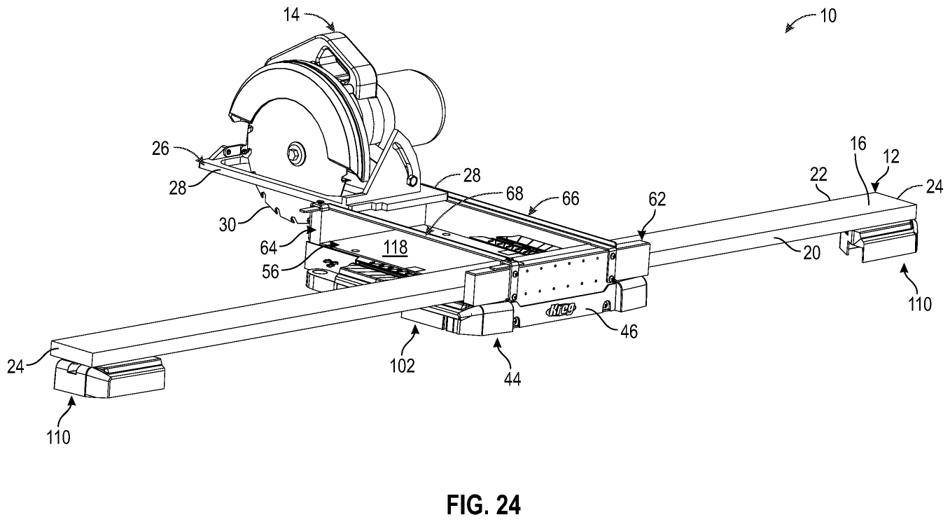

When workpiece 12 is longer than base 44 and longer than the length of support wings 100, support blocks 110 may be removed from support wings 100 and/or arms 102 and placed remotely under workpiece 12. This arrangement is shown as one example, in FIG. 24.

Example of Angled Cut: When cutting an angular cut, workpiece 12 may be placed on base 44 and aligned with angular indicia 74 in the upper surface 54 of base 44 and either held in place by the user during a cutting operation or clamped in place using clamp 76. Alternatively, alignment member 88 may be inserted in track 72, 114 in base 44, support block 110. Alignment member 88 may is set to the desired angular location and then tightened in place. Workpiece 12 is then positioned against fence 92 and thereby aligned at the desired alignment for a cutting operation which is performed in the manners described herein. Clamp 76 may also be used to hold workpiece 12 in place during an angular cut as well.

Notably, alignment member 88 and/or clamp 76 may be inserted in one or both tracks 72, 114 on either side of base 44. Similarly, each support wing 100 may be moved and utilized independent of one another depending on the workpiece 12 that is being cut.

Objectives Met:

From the above discussion it will be appreciated that the improved stationary cross cut system 10 and related methods of use, presented herein improves upon the state of the art.

Specifically, the improved stationary cross cut system 10 and related methods of use presented: is safe to use; is efficient to use; is relatively inexpensive; is capable of making straight cuts; is accurate; is efficient to use; provides precise alignment for a cutting tool; can be used with workpieces with a wide range of thicknesses; can be used with workpieces with a wide range of lengths; can be used with workpieces with a wide range of widths; is unique; is easy to learn how to use; is relatively small in size and shape; provides many of the benefits of a miter saw; holds workpieces in a firm and rigid manner; is easy to set up; is easy to take down; is easy to precisely adjust; can be precisely matched to the blade of a cutting tool; is formed of a minimum number of parts; is simple to use; is easier to use than prior art systems; is more-accurate to use than prior art systems; provides new capabilities to existing tools; has a robust design; is high quality; is durable; has a long useful life; provides accurate and clean cuts; saves time; is fun to use; can be used with workpieces of practically any material; is easily stationary and can be used on a job site; makes it easier to measure cuts; makes measuring more repeatable than prior art systems; and/or can be used with practically any cutting tool, among countless other advantages and improvements.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the following claims, and the full scope of equivalents thereof

What is claimed:

1. A stationary cross cut system, comprising:
a base;
the base having an upper surface;
the upper surface configured to receive a workpiece during a cutting operation;
a first support wing connected to the base;
a second support wing connected to the base;
the first support wing positioned adjacent a first side of the base;
the second support wing positioned adjacent a second side of the base;
wherein the first support wing moves between a retracted position and an extended position;
wherein the second support wing moves between a retracted position and an extended position;
wherein when the first support wing is in an extended position, the first support wing supports a workpiece that extends past the first side of the base;
wherein when the second support wing is in an extended position, the second support wing supports a workpiece that extends past the second side of the base.

2. The system of claim 1, further comprising:
wherein the first support wing connects to the base at a first pivot point;
wherein the second support wing connects to the base at a second pivot point.

3. The system of claim 1, wherein the first support wing includes an arm and a support block.

4. The system of claim 1, wherein the first support wing includes an arm and a support block,
wherein the support block is removable from the arm.

5. The system of claim 1, further comprising the base having first fence and a second fence.

6. The system of claim 1, further comprising a first rail extending between a first fence and a second fence, and a second rail extending between the first fence and the second fence, wherein the first rail and the second rail are configured to receive and guide a cutting tool during a cutting operation.

7. The system of claim 1, wherein when the first support wing is in a retracted position the first support wing is in engagement with the first side of the base.

8. The system of claim 1, wherein when the first support wing is in a retracted position the first support wing extends outward from the first side of the base in an approximate perpendicular alignment.

9. The system of claim 1, wherein the first support wing is infinitely adjustable between the retracted position and the extended position.

10. A stationary cross cut system, comprising:
a base;
the base having an upper surface;
the base having first fence;
the base having a second fence;
the upper surface configured to receive a workpiece between the first fence and the second fence during a cutting operation;
a first rail extending between the first fence and the second fence;
a second rail extending between the first fence and the second fence;
the first rail and second rail configured to receive and guide a cutting tool during a cutting operation;
a first support wing connected to the base;
a second support wing connected to the base;
the first support wing positioned adjacent a first side of the base;
the second support wing positioned adjacent a second side of the base;
wherein the first support wing moves between a retracted position and an extended position;
wherein the second support wing moves between a retracted position and an extended position;
wherein when the first support wing is in an extended position, the first support wing supports a workpiece that extends past the first side of the base;
wherein when the second support wing is in an extended position, the second support supports a workpiece that extends past the second side of the base.

11. The system of claim 10, further comprising:
wherein the first support wing connects to the base at a first pivot point;
wherein the second support wing connects to the base at a second pivot point.

12. The system of claim 10, wherein the first fence and second fence are sacrificial in that the cutting tool is configured to cut through the first fence and second fence during a cutting operation.

13. The system of claim 10, wherein the first fence and second fence are positioned in approximate parallel spaced relation to one another.

14. The system of claim 10, wherein one of the first rail and second rail is fixed in place.

15. The system of claim 10, wherein one of the first rail and second rail is adjustable.

16. The system of claim 10, wherein the first rail and second rail extend in approximate parallel spaced relation to one another.

17. The system of claim 10, wherein the first support wing includes an arm and a support block.

18. The system of claim 10, wherein the first support wing includes an arm and a support block, wherein the support block is removable from the arm.

19. The system of claim 10, wherein when the first support wing is in a retracted position the first support wing is in engagement with the first side of the base.

20. The system of claim 10, wherein when the first support wing is in an extended position the first support wing extends outward from the first side of the base in an approximate perpendicular alignment.

21. The system of claim 10, wherein the first support wing is infinitely adjustable between the retracted position and extended position.

22. A stationary cross cut system, comprising:
a base;
the base having an upper surface;
the base having a first side;
the base having a second side;
the base having first fence;
the base having a second fence;
the upper surface configured to receive a workpiece between the first fence and the second fence during a cutting operation;
a first rail extending between the first fence and the second fence;
a second rail extending between the first fence and the second fence;
the first rail and second rail configured to receive and guide a cutting tool during a cutting operation;
wherein the first rail is fixed;
wherein the second rail includes an adjustment member that facilitates the adjustment of the position of the second rail.

23. The system of claim 22, wherein the first fence and second fence are sacrificial in that the cutting tool is configured to cut through the first fence and second fence during a cutting operation.

24. The system of claim 22, wherein the first rail is screwed or bolted to the first fence and second fence.

25. The system of claim 22, wherein the adjustment member of the second rail is screwed or bolted to the first fence and second fence, wherein the adjustment member of the second rail allows for sliding adjustment of the position of the second rail.

26. The system of claim 22, wherein the first fence and second fence are positioned in approximate parallel spaced relation to one another.

27. The system of claim 22, wherein the first rail and second rail extend in approximate parallel spaced relation to one another.

28. The system of claim 22, further comprising:
a first support wing connected to the base adjacent the first side;
the first support wing having an arm and a support block having an upper surface;
the base having a first track positioned in the upper surface adjacent the first side of the base;
the first support wing having a first track positioned in the upper surface of the support block of the first support wing;
wherein the first support wing pivots between a retracted position and an extended position.

29. The system of claim 22, further comprising:
an alignment member connected to the base;
the alignment member configured to provide angular alignment to the workpiece during a cutting operation.

30. The system of claim 22, further comprising:
an alignment member connected to the base;
the alignment member configured to provide angular alignment to the workpiece during a cutting operation.
wherein the alignment member is configured to connect to a track in the base.

31. The system of claim 22, further comprising:
an alignment member connected to the base;
the alignment member configured to provide angular alignment to the workpiece during a cutting operation.
wherein the alignment member slides in a track in the base.

32. The system of claim 22, further comprising:
an alignment member connected to the base;
the alignment member configured to provide angular alignment to the workpiece during a cutting operation.
wherein the alignment member includes an anchor, a fence and a body, wherein the fence angularly adjusts to align the workpiece at various angles.

33. A stationary cross cut system, comprising:
a base;
the base having an upper surface;
the upper surface configured to receive a workpiece during a cutting operation;
a first support wing connected to the base;
a second support wing connected to the base;
wherein the first support wing moves between a retracted position and an extended position;
wherein the second support wing moves between a retracted position and an extended position;
wherein the first support wing includes an arm and a support block, wherein the support block is removable from the arm;
wherein the second support wing includes an arm and a support block, wherein the support block is removable from the arm;
wherein when the first support wing is in an extended position, the first support wing supports a workpiece that extends past the first side of the base;
wherein when the second support wing is in an extended position, the second support supports a workpiece that extends past the second side of the base.

34. The system of claim 33, wherein when a first end of the workpiece extends past the first side of the base a distance greater than the length of the first support wing, the support block of the first support wing is configured to be removed and placed under the first end of the workpiece thereby supporting the first end of the workpiece remote from the base.

35. The system of claim 33, wherein an upper surface of the support block of the first support wing is approximately the same height as the upper surface of the base.

36. The system of claim 33, wherein the first support wing connects to the base at a first pivot point.

37. A stationary cross cut system, comprising:
a base;
the base having an upper surface;
the upper surface configured to receive a workpiece during a cutting operation;
a first support wing connected to the base;
wherein the first support wing moves between a retracted position and an extended position;
wherein the first support wing includes an arm and a support block, wherein the support block is removable from the arm;
wherein when the first support wing is in an extended position, the first support wing supports a workpiece that extends past the first side of the base;
wherein when a first end of the workpiece extends past the first side of the base a distance greater than the length of the first support wing, the support block of the first support wing is configured to be removed and placed under the first end of the workpiece thereby supporting the first end of the workpiece remote from the base.

38. The system of claim 37, wherein an upper surface of the support block of the first support wing is approximately the same height as the upper surface of the base.

39. The system of claim 37, wherein the first support wing connects to the base at a first pivot point.

40. The system of claim 37, further comprising a first rail extending between a first fence and a second fence, and a second rail extending between the first fence and the second fence, wherein the first rail and the second rail are configured to receive and guide a cutting tool during a cutting operation.
